(19) United States
(12) Patent Application Publication
(10) Pub. No.: US 2007/0003882 A9
(43) Pub. Date: Jan. 4, 2007

(54) Photothermographic material, and image forming method using same

(76) Inventor: Kouta Fukui, Kanagawa (JP)

Correspondence Address: TAIYO CORPORATION, 401 HOLLAND LANE, #407, ALEXANDRIA, VA, 22314, US

(21) Appl. No.: 10/658,470

(22) Filed: Sep. 10, 2003

Related U.S. Application Data
(63) Continuation-in-part of application No. 10/002,170, filed on Dec. 5, 2001, now Pat. No. 6,682,878.

(30) Foreign Application Priority Data
Sep. 13, 2002 (JP) 2002-267756

(51) Int. Cl. G03C 1/498; G03C 1/37

(52) U.S. Cl. 430/350; 430/529; 430/600; 430/613; 430/619

(57) ABSTRACT

The present invention provides a photothermographic material comprising a substrate and a composition provided thereon. The composition includes a photosensitive silver halide, a non-photosensitive organic silver salt, a reducing agent for thermal development and a binder. Each of organic compounds comprised in an amount of approximately 0.05 g/m² or more in the composition has a volatilization remaining ratio of 50% or more at 160° C. The photothermographic material preferably comprises, as a color tone adjuster, a combination of a phthalazine acid and a phthalic acid compound each having a specific structure. The invention further provides a method for producing the imaged photothermographic material. In the production of this material, a thermal developing device having a filter for collecting volatilized material is used.

### CROSS-REFERENCE TO RELATED APPLICATIONS

This application claims benefit of and priority to Japanese Patent Application No. 2002-267756 which is incorporated herein by reference in its entirety.

### BACKGROUND OF THE INVENTION

1. Field of the Invention

The present invention relates to a photothermographic material, and an image forming method.

2. Description of the Related Art

In recent years, it has been desired in the medical field to decrease the amount of liquid waste from the viewpoints of environment preservation and economy of space. Thus there is a need for technology relating to photosensitive thermal developing photographic materials for medical diagnosis and photographic technology which can be effectively exposed to light by means of a laser image setter or a laser imager and can give vivid black images having high resolution and sharpness. These photosensitive thermal developing photographic materials, can supply customers with simpler thermal development systems which do not need to use any solution type processing chemical agents and do not harm the environment.

Similar technology has been desired in the field of ordinary image forming materials. In particular, for medical imaging minute detailed depiction is desired; therefore, high-quality images, which are superior in sharpness and granularity, are necessary and further cold and black tone images are preferred from the viewpoint of ease of diagnosis based on the images. At present, various hard copy systems using pigment or dye, such as inkjet printers or electrophotographic systems, are in circulation as ordinary image forming systems. However, satisfactory systems for outputting images for medicine do not exist.

Thermal image forming systems using organic silver salts are described in, for example, U.S. Pat. Nos. 3,152,904 and 3,457,075, and B. Shely, “Thermally Processed Silver Systems” (Imaging Processes and Materials, Neblette, Vol. 8, edited by Sturge, V. Walworth, and A Shepp, 1989), the entire disclosure of which is incorporated herein by reference. In particular, a photothermographic material generally has a photosensitive layer wherein a catalytic activity amount of a photocatalyst (for example, a silver halide), a reducing agent, a silver salt which can be reduced (for example, an organic silver salt), and an optional color tone adjuster for controlling the color tone of silver are dispersed in the matrix made of a binder. The photothermographic material is imagewise exposed to light, and then heated at a high temperature (for example, 80° C. or higher) so as to cause redox reaction between the silver halide or the silver salt that can be reduced, which functions as an oxidizer, and the reducing agent. In this way, a black silver image is formed. The redox reaction is promoted by a catalytic effect of a latent image of the silver halide which is generated by the exposure. Thus, the black silver image is formed in the exposed area. A Fuji Medical Dry Imager FM-DP L (trade name), which is disclosed in many documents including U.S. Pat. No. 2,910,377 and Japanese Patent Application Publication (JP-B) No. 43-4924, has been sold as a system for forming images for medicine on the basis of photothermographic material.

The production of heat image forming systems using organic silver salts is classified into a production method using application of a solvent, and a production method of applying a coating-solution in which fine polymer particles as a main binder are dispersed in water, and drying the applied solution. Since the latter method does not require the step of solvent-recollection, the production facilities therefor are simple and the method is profitable for mass-production.

The image forming method using the above-mentioned photothermographic material is a method in which environment is taken into consideration since no solution-type processing chemical agent is necessary for the method. However, heat is applied to the photosensitive material in order to form images; therefore, the method has problems that in that a bad odor may be generated at the time of thermal development and stains may be generated in the thermal developing device.

Japanese Patent Application National Publication (Laid-Open) No. 2000-501845 and Japanese Patent Application Laid-Open (JP-A) No. 2002-23338 disclose use of a filter cartridge but does not completely solve the aforementioned problems.

Compounds represented by the following general formula (I) are known. However, there is no known relationship between the structure or physical property of these compounds and the volatilization thereof or odors released at the time of thermal development in the case that the compounds are used in photothermographic materials. Hitherto, such problems have not been recognized.

### SUMMARY OF THE INVENTION

An object of the present invention is to provide a photothermographic material which generates little odor and minimizes stains in a thermal developing device; and an image forming method.

That is, a first aspect of the invention is to provide a photothermographic material which comprises, on or over a single surface of a substrate, a photosensitive silver halide, a non-photosensitive organic silver salt, a reducing agent for thermal development, and a binder, wherein each of organic compounds comprised in an amount of approximately 0.05 g/m² or more in the composition has a volatilization remaining ratio of 50% or more at 160° C.

In the above-mentioned photothermographic material, at least one of the organic compounds may be represented by the following general formula (I): 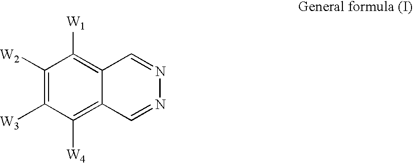
wherein W₁ to W₄ each independently represent a hydrogen atom or a monovalent substituent, and at least one of W₁ to W₄ is a monovalent substituent.

In the photothermographic material, at least one of the organic compounds may be represented by the following general formula (II): 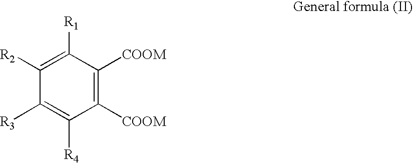
wherein R₁ to R₄ each independently represent a hydrogen atom or a monovalent substituent, and when three out of R₁ to R₄ are each a hydrogen atom, the remaining monovalent substituent is a group other than a methyl group; and M represents a hydrogen atom, an alkali metal, an alkali earth metal, an ammonium group, or a phosphonium group.

The photothermographic material may comprise at least one selected from the compounds represented by the general formula (I) and at least one selected from the compounds represented by the general formula (II), the selected compounds being the organic compounds.

A second aspect of the invention is to provide an image forming method of using a photothermographic material which comprises, on or over a single surface of a substrate, a photosensitive silver halide, a non-photosensitive organic silver salt, a reducing agent for thermal development, and a binder to form an image by heating by means of a thermal developing device, wherein 1) the composition comprises organic compounds, each in an amount of approximately 0.05 g/m² or more, and each of the compounds has a volatilization remaining ratio of 50% or more at 160° C.; and 2) the thermal developing device comprises a filter for collecting volatilized substances.

In the above-mentioned image forming method, at least one of the organic compounds may be represented by the following general formula (I).

In the above-mentioned image forming method, at least one of the organic compounds may be represented by the following general formula (II).

In the above-mentioned image forming method, the time for thermal development ranges from 7 to 15 seconds.

In the above-mentioned image forming method, the filter for collecting volatilized substances may contain one or more absorbents selected from activated carbon, zeolite, and silica.

### BRIEF DESCRIPTION OF THE DRAWINGS

FIG. 1 is a schematic view illustrating an embodiment of a thermal developing device used in the present invention.

### DETAILED DESCRIPTION OF THE INVENTION

The present invention will be described in detail hereinafter.

Description on the Volatilization Remaining Ratio

The wording “volatilization remaining ratio at 160° C.” in the invention is defined as follows.

A commercially available TG/DTA simultaneously-measuring device (a thermo gravimetry/differential thermal analysis simultaneously-testing device, for example, TG/DTA 6200 (trade name) manufactured by Seiko Instruments Inc.) is used to raise the temperature of a sample bulk to be measured to 160° C. The weight thereof after 15 minutes from attaining the temperature of 160° C. is regarded as a standard (100%). The percentage of the remaining weight after one hour therefrom to the standard is defined as the volatilization remaining ratio. In this case, water content taken in the crystal evaporates within 15 minutes of the start. For example, if the percentage of the amount of the sample bulk remaining after one hour is 60% of the standard, the volatilization remaining ratio is 60%.

The volatilization remaining ratio specified in the invention is 50% or more, preferably 70% or more.

Description on the Organic Compounds

In the wording “organic compounds comprised in an amount of approximately 0.05 g/m² or more” in the invention, the organic compounds mean compounds having a molecular weight of 1000 or less, and the category of the compounds does not include any polymer compound. The organic compounds mean photographically useful compounds such as an organic silver salt, a reducing agent, a color tone adjuster, an anti-fogging agent, a developing promoter, and a dye. The adding amount of each of the organic compounds indicated above is 0.05 g/m² or more, preferably 0.1 g/m² or more.

Description on the Organic Silver Salt

The organic silver salt which can be used in the invention is a silver salt which is relatively stable against light but functions as a silver ion supplier to form a silver image when the salt is heated to 80° C. or higher in the presence of an exposed photosensitive silver halide and a reducing agent. The organic silver salt may be any organic substance which can be reduced by a reducing agent so as to make it possible to supply a silver ion. Such a non-photosensitive organic silver salt is described in JP-A No. 10-62899, paragraphs 0048 to 49, EP-A1 No. 0803764, page 18, line 24 to page 19, line 37, EP-A1 No. 0962812, JP-A Nos. 11-349591, 2000-7683 and 2000-72711, and other documents. Silver salts of an organic acid are preferred, and silver salts of long-chain aliphatic carboxylic acid (having 10 to 30 carbon atoms, preferably 15 to 28 carbon atoms) are particularly preferred. Preferred examples of the aliphatic acid silver salts include silver lignocerate, silver behenate, silver arachidate, silver stearate, silver oleate, silver laurate, silver caprate, silver myristate, silver palmitate, silver erucate, and mixtures thereof.

When thermal development advances so that developed silver is generated, an organic acid is isolated from the above-mentioned organic acid salt so that a part thereof may become volatile. As an organic acid has a lower molecular weight, the acid portion volatilizes more easily. Thus, in order to prevent the volatilization and scattering, it is preferable to use an organic acid having a higher molecular weight. However, if the molecular weight is too high, thermal development is impaired. Therefore, the molecular weight of the organic acid has an optimal range. The molecular weight of the organic acid is preferably from 150 to 500, more preferably from 300 to 400.

In the invention, it is preferred to use, among aliphatic acid silvers, aliphatic acid silvers which preferably have a silver behenate content of 50% or more, more preferably 85% or more and most preferably 95% or more by mole. Furthermore, it is preferred to use aliphatic acid silvers which preferably have a silver erucate content of 2% or less, more preferably 1% or less and most preferably 0.1% by mole or less.

The shape of the organic silver salt which can be used in the invention is not particularly limited, and may include needle, rod, tubular and flake-like shapes.

In the invention, the flake-like organic silver salt particles are preferred. Short needle particles which have a ratio of their long axis to their short axis of 5 or less, rectangular parallelepiped particles, cubic particles, or indeterminate shaped particles (or potato form particles) are also preferably used. Using these organic silver particles, fogging is minimized at the time of thermal development as opposed to the use of long-needle form particles having a ratio of their long axis to their short axis of 5 or more. Particles having a ratio of their long axis to their short axis of 3 or less are particularly preferred since the mechanical stability of the coating membrane obtained therefrom is improved. In the present specification, the scaly flake-shaped silver salt is defined as follows. An organic acid silver salt particle is observed with an electron microscope, and the shape of the organic acid silver salt particle is approximated to a rectangular parallelepiped. When the shortest side of this rectangular parallelepiped, the second shortest side thereof, and the longest side thereof are represented by a, b, and c, respectively (c may be equal to b), values a and b, which are not the longest value, are used to calculate x from the following equation:
x=b/a

Using about 200 particles, x's thereof are obtained as described above. The average thereof is obtained as x (average). Particles satisfying the inequality: x (average)≧1.5 are defined as flake-shaped particles. Preferably, the inequality: 30≧x (average)≧1.5 is satisfied, and more preferably the inequality: 15≧x (average)≧1.5 is satisfied. Incidentally, needle particles satisfy the inequality: 1≦x (average)<1.5.

In a flake-shaped particle, a can be regarded as the thickness of a tabular particle having a main face made of a face having sides b and c. In flake-shaped particles, the average of a's is preferably 0.01 μm or more and 0.3 μm or less, more preferably 0.1 μm or more and 0.23 μm or less. The average of (c/b)'s is preferably 1 or more and 6 or less, more preferably 1 or more and 4 or less, and most preferably 1 or more and 3 or less.

The distribution of particle sizes of the organic silver salts is preferably mono-dispersible. The word “mono-dispersible” means that the percentage of the value obtained by dividing the standard deviation of short axes or long axes by the short axes or the long axes is preferably 100% or less, more preferably 80% or less, and most preferably 50% or less. The shape of the organic silver salt can be obtained from a transmission electron microscope image of a product wherein the organic silver salt is dispersed. Another method for measuring the mono-dispersibility is a method of obtaining the standard deviation of the volume-added average diameter of the organic silver salt particles. The percentage (variation coefficient) of the value obtained by dividing the standard deviation by the volume-added average diameter is preferably 100% or less, more preferably 80% or less, and most preferably 50% or less. This percentage can be obtained, for example, from the particle size (volume-added average diameter) obtained by radiating a laser ray onto the organic silver salt particles dispersed in a solution and then calculating an autocorrelation function to time change in fluctuation motion of the scattered light therefrom.

For the production of the organic silver salt used in the invention and the dispersion thereof, known methods can be used. For example, the following can be referred to: the above-mentioned JP-A No. 10-62899, EP-A1 Nos. 0803763 and 0962812, and JP-A Nos. 11-349591, 2000-7683, 2000-72711, 2001-163889, 2001-163890, 2001-163827, 2001-33907, 2001-188313, 2001-83652, 2002-6442, 2002-49117, 2002-31870, and 2002-107868.

If a photosensitive silver salt is caused to coexist when the organic silver salt is dispersed, fog increases so that the sensitivity falls markedly. It is therefore preferred that no photosensitive silver salt is incorporated at the time of the dispersion. In the invention, the amount of the photosensitive silver salt in the solution in which the organic silver salt is dispersed in water is preferably 1% or less, more preferably 0.1% by mole or less per mole of the organic acid silver salt in the solution. Most preferably, any photosensitive silver salt is not positively added thereto.

In the invention, a photosensitive material can be produced by mixing a solution in which an organic silver salt is dispersed in water with a solution in which a photosensitive silver salt is dispersed in water. The blend ratio of the photosensitive silver salt to the organic silver salt, which can be selected in accordance with intended use, is preferably from 1 to 30% by mole, more preferably from 2 to 20% by moles, and most preferably from 3 to 15% by mole. The method of mixing two or more organic silver salt dispersed solutions with two or more photosensitive silver salt dispersed solutions is preferred for adjusting photographic property.

In the invention, the organic silver salt can be used in a desired amount. The total amount of applied silver including silver halide is preferably from 0.1 to 5.0 g/m², more preferably from 0.3 to 3.0 g/m², and most preferably from 0.5 to 2.0 g/m². In particular, in order to improve the image storability, the total amount of applied silver is preferably 1.8 g/m² or less, more preferably 1.6 g/m² or less. When a preferred reducing agent in the invention is used, a sufficient image density can be obtained even when using such a low silver amount.

Description on a Reducing Agent

The photothermographic material of the invention contains a reducing agent for the organic silver salt. The reducing agent for the organic silver salt may be any material (preferably, organic material) for reducing a silver ion to a metal silver atom. Examples of this reducing agent are described in JP-A No. 11-65021, paragraphs 0043 to 0045, and EP-A1 No. 0803764, page 7, line 34 to page 18, line 12.

A part of the reducing agent may become volatile during thermal development. As the molecular weight of the reducing agent is lower, the reducing agent volatilizes more easily. In order to prevent such volatilization and scattering, it is favorable to make the molecular weight of the reducing agent high. However, if the molecular weight is too high, thermal development is impaired. It is preferred to use a reducing agent made of a dimer so as to have a high molecular weight since the volatilization and scattering of the reducing agent can be suppressed without the activity thereof being lowered. In the invention, particularly preferred is a bisphenol type reducing agent having, at an ortho position of its phenolic hydroxyl group, a substituent. The molecular weight thereof is preferably from 200 to 500, more preferably from 250 to 400.

The reducing agent in the invention is more preferably a compound represented by the following general formula (R): 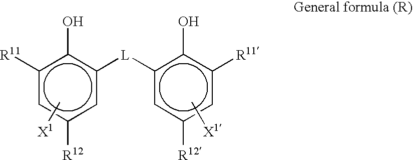
wherein R¹¹ and R^{11′} each independently represent an alkyl group having 1 to 20 carbon atoms, R¹² and R^{12′} each independently represent a hydrogen atom or a substituent which can be substituted on the benzene ring, L represents a —S— group or a —CHR¹³— group wherein R¹³ represents a hydrogen atom or an alkyl group having 1 to 20 carbon atoms, and X¹ and X^{1′} each independently represent a hydrogen atom or a substituent which can be substituted on the benzene ring.

The following will describe the general formula (R) in detail.

R¹¹ and R^{11′} each independently represent a substituted or non-substituted alkyl group having 1 to 20 carbon atoms. The substituent of the alkyl group is not particularly limited, and preferred examples thereof include aryl, hydroxyl, alkoxy, aryloxy, alkylthio, arylthio, acylamino, sulfonamide, sulfonyl, phosphoryl, acyl, carbamoyl, ester, ureido and urethane groups, and halogen atoms.

R¹² and R^{12′} each independently represent a hydrogen atom or a substituent which can be substituted on the benzene ring. In the same manner, X¹ and X^{1′} each independently represent a hydrogen atom or a substituent which can be substituted on the benzene ring. Preferred examples of the substituent which can be substituted on the benzene ring include alkyl, aryl, alkoxy, and acylamino groups, and halogen atoms.

L represents a —S— group or a —CHR¹³— group wherein R¹³ represents a hydrogen atom or an alkyl group having 1 to 20 carbon atoms. The alkyl group may have a substituent. Specific examples of the alkyl group which is not substituted, as R¹³, include methyl, ethyl, propyl, butyl, heptyl, undecyl, isopropyl, 1-ethylpentyl, and 2,4,4-trimethylpentyl groups. Examples of the substituent of the alkyl group are the same as described as the substituent of R¹¹.

Preferably, R¹¹ and R^{11′} are each a secondary or tertiary alkyl group having 3 to 15 carbon atoms. Specific examples thereof include isopropyl, isobutyl, t-butyl, t-amyl, t-octyl, cyclohexyl, cyclopentyl, 1-methylcylohexyl, and 1-methylcyclopropyl groups. R¹¹ and R^{11′} are each more preferably tertiary alkyl group having 4 to 12 carbon atoms, still more preferably a t-butyl, t-amyl, or 1-methylhexyl group, and most preferably a t-butyl group.

Preferably, R¹² and R^{12′} are each an alkyl group having 1 to 20 carbon atoms. Specific examples thereof include methyl, ethyl, propyl, butyl, isopropyl, t-butyl, t-amyl, cyclohexyl, 1-methylcylohexyl, benzyl, methoxymethyl, and methoxyethyl groups. R¹² and R^{12′} are each more preferably a methyl, ethyl, propyl, isopropyl or t-butyl group.

X¹ and X¹′ are each preferably a hydrogen atom, a halogen atom, or an alkyl group, more preferably a hydrogen atom.

L is preferably a —CHR¹³— group.

R¹³ is preferably a hydrogen atom or an alkyl group having 1 to 15 carbon atoms. Preferred examples of the alkyl group include methyl, ethyl, propyl, isopropyl, and 2,4,4-trimethylpentyl. Particularly preferred examples of R¹³ include a hydrogen atom, and methyl, ethyl, propyl and isopropyl group.

When R¹³ is a hydrogen atom, R¹² and R^{12′} are each preferably an alkyl group having 2 to 5 carbon atoms, more preferably an ethyl or propyl group, and most preferably an ethyl group.

When R¹³ is a primary or secondary alkyl group having 1 to 8 carbon atoms, R¹² and R^{12′} are each preferably a methyl group. The primary or secondary alkyl group having 1 to 8 carbon atoms, as R¹³, is more preferably a methyl, ethyl, propyl or isopropyl group, still more preferably a methyl, ethyl or propyl group.

When R¹¹, R^{11′}, R¹² and R^{12′} are each a methyl group, R¹³ is preferably a secondary alkyl group. In this case, the secondary alkyl group, as R¹³, is preferably an isopropyl, isobutyl or 1-ethylpentyl group, more preferably an isopropyl group.

The above-mentioned reducing agents have different thermal developability, and developed silver color tones depending upon the combination of R¹¹, R^{11′}, R¹² and R^{12′}. Typically two or more reducing agents are selected and combined to adjust these properties, it is preferred to use such a combination is advantageously used in the photothermographic materials of the present invention.

The following will illustrate specific examples of the reducing agent in the invention, including the compounds represented by the general formula (R). In the invention, however, the reducing agent is not limited to these examples.

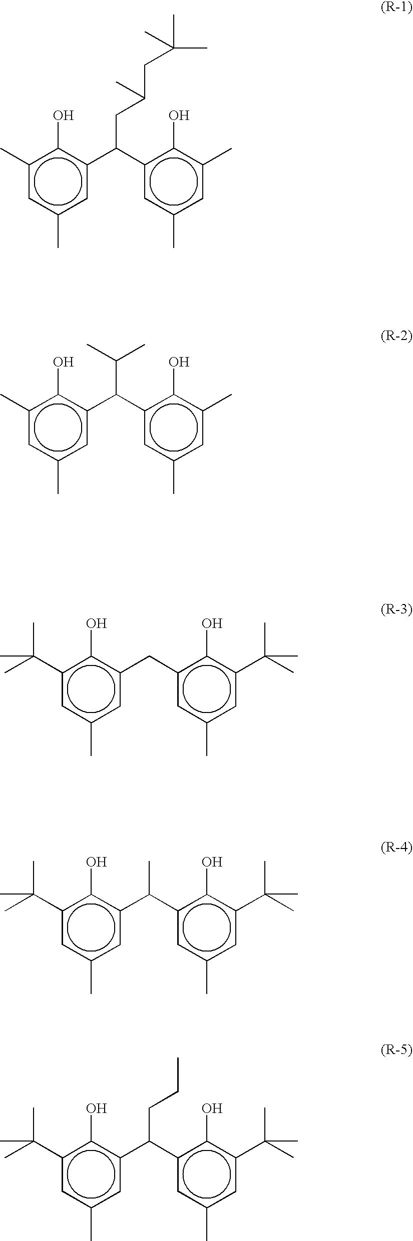

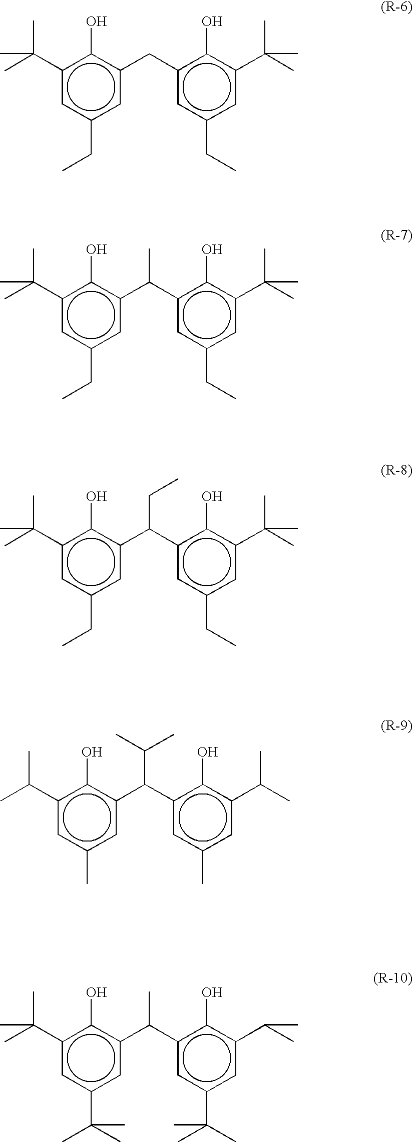

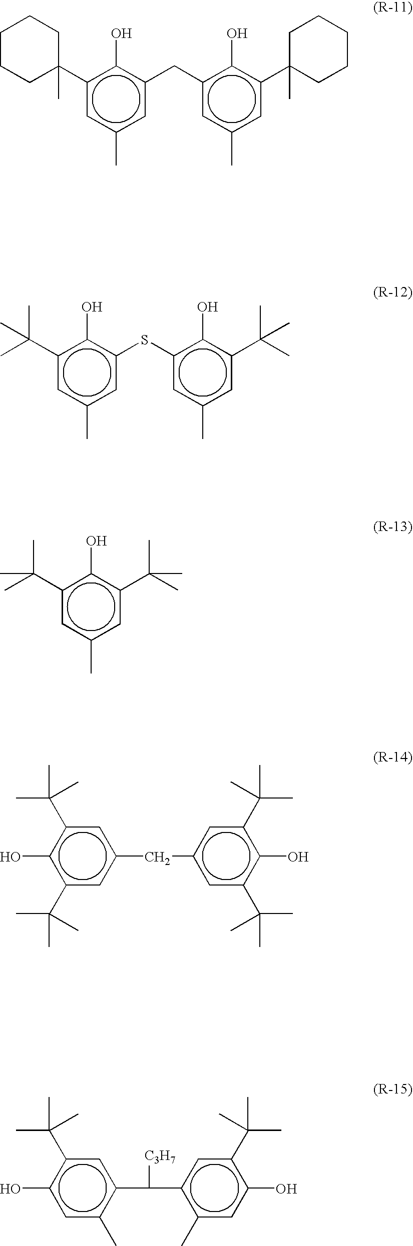

Preferred examples of the reducing agent in the invention include compounds described in JP-A Nos. 2001-188314, 2001-209145, 2001-350235 and 2002-156727, besides the above-mentioned examples.

In the invention, the adding amount of the reducing agent is preferably from 0.1 to 3.0 g/m², more preferably from 0.2 to 1.5 g/m², and most preferably from 0.3 to 1.0 g/m². The amount of the reducing agent is preferably from 5 to 50%, more preferably from 8 to 30% and most preferably from 10 to 20% by mole per mole of silver in the surface having an image forming layer. The reducing agent is preferably incorporated into the image forming layer.

The reducing agent may be incorporated into a coating-solution of the invention so as to be incorporated into the photosensitive material in any manner such as in a solution, in an emulsion dispersion, or in a solid fine particle dispersion.

A well-known example of an emulsion dispersion technique uses an oil such as dibutyl phthalate, tricresyl phosphate, glyceryl triacetate or diethyl phthalate, or a cosolvent such as ethyl acetate or cyclohexanone to dissolve the reducing agent and prepare an emulsion dispersion mechanically.

An example of the solid fine particle dispersion technique involves dispersing powder of the reducing agent into a suitable solvent such as water by means of a ball mill, a colloid mill, a vibrating ball mill, a sand mill, a jet mill or a roller mill, or by ultrasonic waves to prepare a solid dispersion. At this time, a protective colloid (such as polyvinyl alcohol), or a surfactant (such as an anionic surfactant, for example, sodium triisopropylnaphthalenesulfonate (a mixture of such sodium salts wherein the substitution positions of the three isopropyl groups are different)) may be used. In the above-mentioned mills, beads made of zirconia or the like are usually used as dispersing media. Zr or the like eluted from these beads may be incorporated into the dispersion. The amount thereof, which depends on dispersion conditions, is usually from 1 ppm to 1000 ppm. If the Zr content in the photosensitive material is 0.5 mg or less per gram of silver, no practical problem is caused. It is preferred to incorporate a preservative (such as a sodium salt of benzoisothiazolinone) into the dispersion wherein the reducing agent is dispersed in water. In the invention, the reducing agent is preferably used in the form of a solid dispersion.

Description on a Color Tone Adjuster

The photothermographic material of the invention preferably contains a color tone adjuster.

The color tone adjuster is described in, for example, JP-A No. 10-62899, paragraphs 0054 to 0055, EP-A1 No. 0803764, page 21, lines 23-48, and JP-A Nos. 2000-356317 and 2000-187298. Specific examples thereof include phthalazinone compounds (i.e., phthalazinone, phthalazinone derivatives and metal salts of phthalazinone, such as 4- (1-naphthyl) phthalazinone, 6-chlorophthalazinone, 5,7-dimethoxyphthalazinone, and 2,3dihydro-1,4-phthalazinone); combinations of any phthalazinone compound with any one of phthalic acid compounds (such as phthalic acid, 4-methylphthalic acid, 4-nitrophthalic acid, diammonium phthalate, sodium phthalate, potassium phthalate, and tetrachlorophthalic anhydride); phthalazine compounds (i.e., phthalazine, phthalazine derivatives and metal salts of phthalazines, such as 4-(1-naphthyl)phthalazine, 6isopropylphthalazine, 6-t-butylphthalazine, 6chlorophthalazine, 5,7-dimethoxyphthalazine, and 2,3dihydrophthalazine; and combinations of any phthalazine compound with any phthalic acid compound.

In the invention, it is preferred to use, as the color tone adjuster, a combination of a phthalazine compound with a phthalic acid compound.

As the phthalazine compound, a compound selected from compounds represented by the following general formula (I) is preferred. 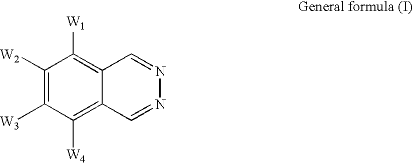
wherein W₁, W₂, W₃ and W₄ each independently represent a hydrogen atom or a monovalent substituent, and at least one thereof is a monovalent substituent.

Examples of the substituent represented by each of W₁ to W₄ include alkyl groups (preferably having 1 to 20 carbon atoms, more preferably 1 to 12 carbon atoms, and most preferably 1 to 8 carbon atoms), such as methyl, ethyl, n-propyl, iso-propyl, n-butyl, iso-butyl, tert-butyl, n-octyl, n-decyl, n-hexadecyl, cyclopropyl, cylcopentyl, and cyclohexyl groups; alkenyl groups (preferably having 2 to 20 carbon atoms, more preferably 2 to 12 carbon atoms, and most preferably 2 to 8 carbon atoms), such as vinyl, allyl, 2-butenyl, and 3-pentenyl groups; alkynyl groups (preferably having 2 to 20 carbon atoms, more preferably 2 to 12 carbon atoms, and most preferably 2 to 8 carbon atoms), such as propargyl and 3-pentynyl groups; aryl groups (preferably having 6 to 30 carbon atoms, more preferably 6 to 20 carbon atoms, and most preferably 6 to 12 carbon atoms), such as phenyl, p-methylphenyl and naphthyl groups; amino groups (preferably having 0 to 20 carbon atoms, more preferably 0 to 10 carbon atoms, and most preferably 0 to 6 carbon atoms), such as amino, methylamino, dimethylamino, diethylamino and dibenzylamino groups; alkoxy groups (preferably having 1 to 20 carbon atoms, more preferably 1 to 12 carbon atoms, and most preferably 1 to 8 carbon atoms), such as methoxy, ethoxy and butoxy groups; aryloxy groups (preferably having 6 to 20 carbon atoms, more preferably 6 to 16 carbon atoms, and most preferably 6 to 12 carbon atoms), such as phenyloxy and 2-naphthyloxy groups; acyl groups (preferably having 1 to 20 carbon atoms, more preferably 1 to 16 carbon atoms, and most preferably 1 to 12 carbon atoms), such as acetyl, benzoyl, formyl, and pivaloyl groups; alkoxycarbonyl groups (preferably having 2 to 20 carbon atoms, more preferably 2 to 16 carbon atoms, and most preferably 2 to 12 carbon atoms), such as methoxycarbonyl, ethoxycarbonyl, and cylohexyloxycarbonyl groups; aryloxycarbonyl groups (preferably having 7 to 20 carbon atoms, more preferably 7 to 16 carbon atoms, and most preferably 7 to 10 carbon atoms), such as a phenyloxycarbonyl group; acyloxy groups (preferably having 2 to 20 carbon atoms, more preferably 2 to 16 carbon atoms, and most preferably 2 to 10 carbon atoms), such as acetoxy and benzoyloxy groups; acylamino groups (preferably having 2 to 20 carbon atoms, more preferably 2 to 16 carbon atoms, and most preferably 2 to 10 carbon atoms), such as acetylamino and benzoylamino groups; alkoxycarbonylamino groups (preferably having 2 to 20 carbon atoms, more preferably 2 to 16 carbon atoms, and most preferably 2 to 12 carbon atoms), such as a methoxycarbonylamino group; aryloxycarbonylamino groups (preferably having 7 to 20 carbon atoms, more preferably 7 to 16 carbon atoms, and most preferably 7 to 12 carbon atoms), such as a phenyloxycarbonylamino group; sulfonylamino groups (preferably having 1 to 20 carbon atoms, more preferably 1 to 16 carbon atoms, and most preferably 1 to 12 carbon atoms), such as methanesulfonylamino, and benzenesulfonylamino groups; sulfamoyl groups (preferably having 0 to 20 carbon atoms, more preferably 0 to 16 carbon atoms, and most preferably 0 to 12 carbon atoms), such as sulfamoyl, methylsulfamoyl, dimethylsulfamoyl and phenylsulfamoyl groups; carbamoyl groups (preferably having 1 to 20 carbon atoms, more preferably 1 to 16 carbon atoms, and most preferably 1 to 12 carbon atoms), such as carbamoyl, methylcarbamoyl, ethylcarbamoyl, diethylcarbamoyl, phenylcarbamoyl groups; alkylthio groups (preferably having 1 to 20 carbon atoms, more preferably 1 to 16 carbon atoms, and most preferably 1 to 12 carbon atoms), such as methylthio and ethylthio group; arylthio groups (preferably having 6 to20 carbon atoms, more preferably 6 to 16 carbon atoms, and most preferably 6 to 12 carbon atoms), such as a phenylthio group; sulfonyl groups (preferably having 1 to 20 carbon atoms, more preferably 1 to 16 carbon atoms, and most preferably 1 to 12 carbon atoms), such as mesyl and tosyl groups; sulfinyl groups (preferably having 1 to 20 carbon atoms, more preferably 1 to 16 carbon atoms, and most preferably 1 to 12 carbon atoms), such as methanesulfinyl and benzenesulfinyl groups; ureido groups (preferably having 1 to 20 carbon atoms, more preferably 1 to 16 arbon atoms, and most preferably 1 to 12 carbon atoms), such as ureido, methylureido, butylureido, and phenylureido groups; phosphoric amides (preferably having 1 to 20 carbon atoms, more preferably 1 to 16 carbon atoms, and most preferably 1 to 12 carbon atoms), such as diethylphosphoric amide, and phenylphosphoric amide groups; a hydroxyl group; a mercapto group; halogen atoms (such as fluorine, chlorine, bromine and iodine atoms); a cyano group; a sulfo group; a carboxyl group; a nitro group; a hydroxamic acid group; a sulfino group; a hydrazino group; and heterocyclic groups (such as imidazolyl, pyridyl, furyl, piperidino, and morpholino groups). These substituents may be substituted with a substituent.

W₁ to W₄ are each preferably a hydrogen or halogen atom, or an alkyl, aryl, amino, alkoxy, aryloxy, acyamino, sulfonylamino, carbamoyl or hydroxyl group, more preferably a hydrogen atom or a halogen atom, or an alkyl, aryl, alkoxy, aryloxy, acyamino or suylfonylamino group.

The group represented by each of W₁ to W₄ is most preferably a hydrogen atom or an alkyl group having 1 to 4 carbon atoms. At least one of W₁ to W₄ is preferably an alkyl group having 1 to 4 carbon atoms. Two or three out of the groups represented by W₁ to W₄ are preferably hydrogen atoms.

The monovalent substituent represented by each of W₁ to W₄ in the compound represented by the general formula (I) in the invention may be further substituent with a substituent. Preferred examples of the substituent are the same as described as examples of W₁ to W₄ with the exception of a hydrogen atom.

Adjacent two out of W₁ to W₄ may be bonded to each other to form a ring. Examples of the ring include a benzene ring and a 1,3-dioxolane ring.

The following will illustrate typical examples of the compound represented by the general formula (I) in the invention. In the invention, however, the compound is not limited to these examples.

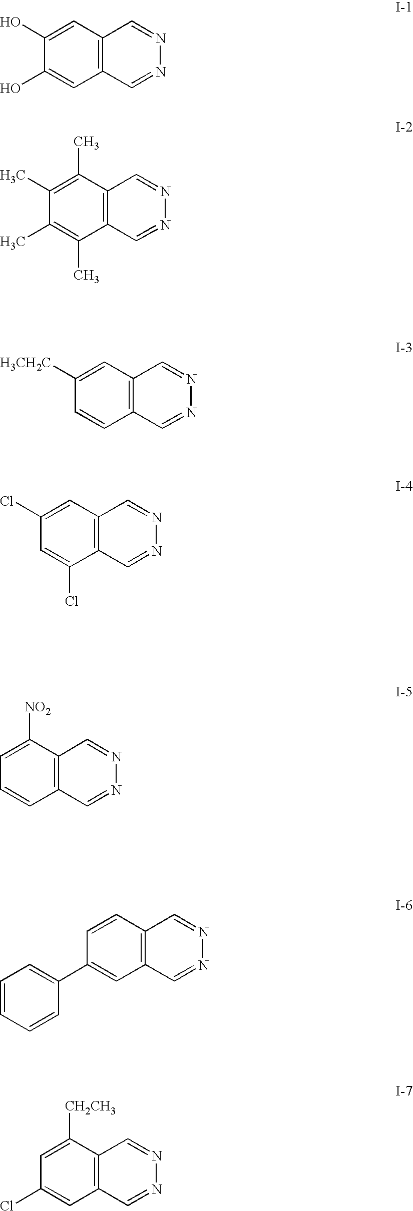

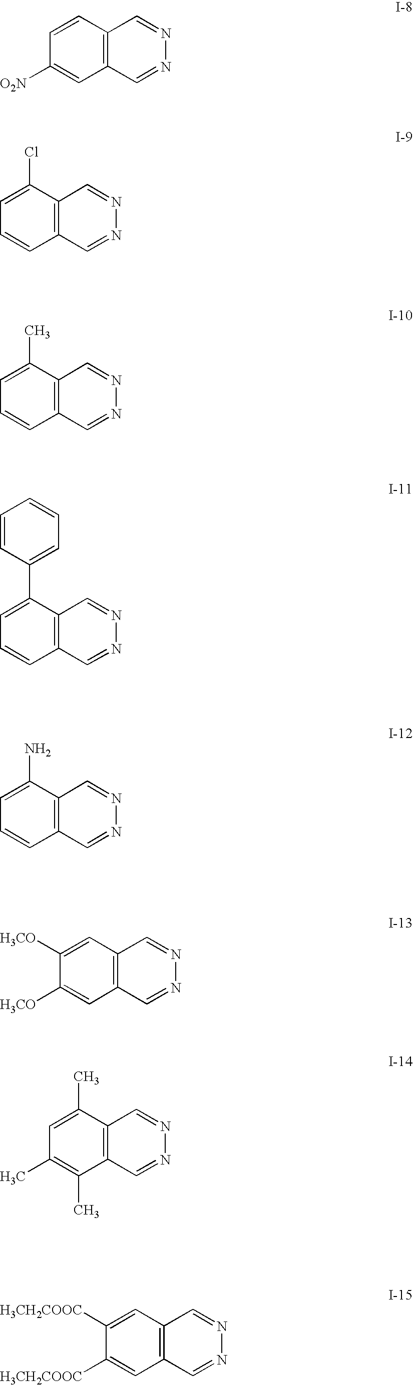

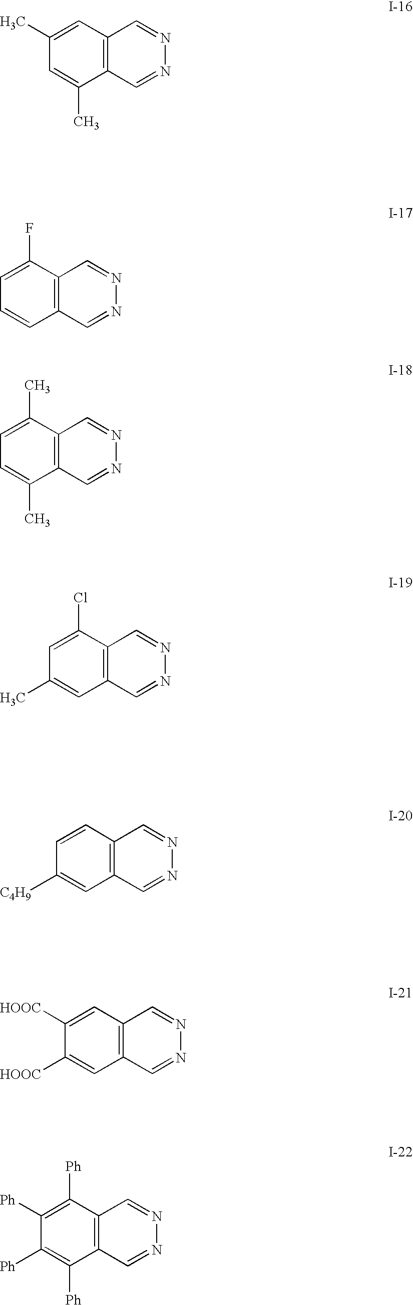

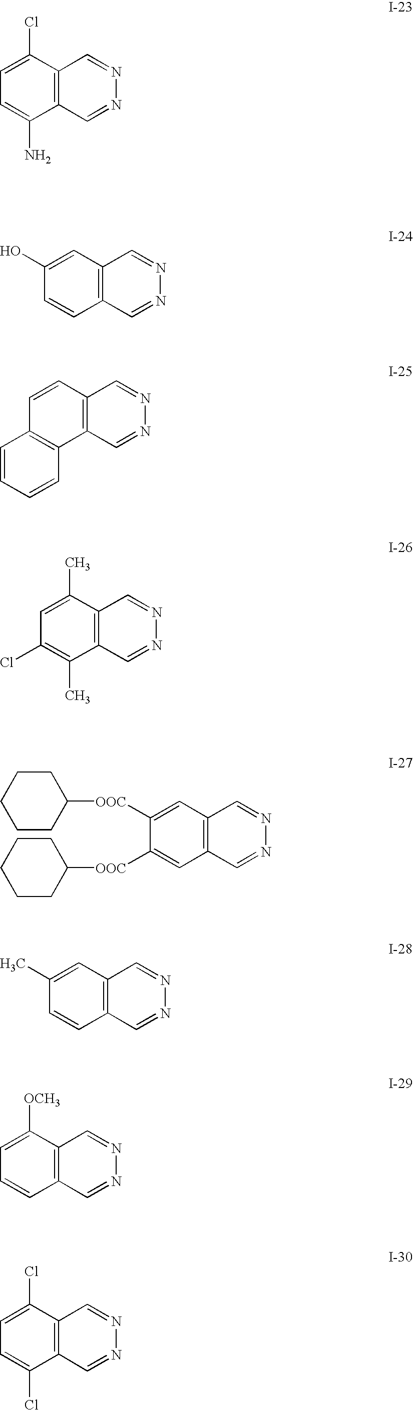

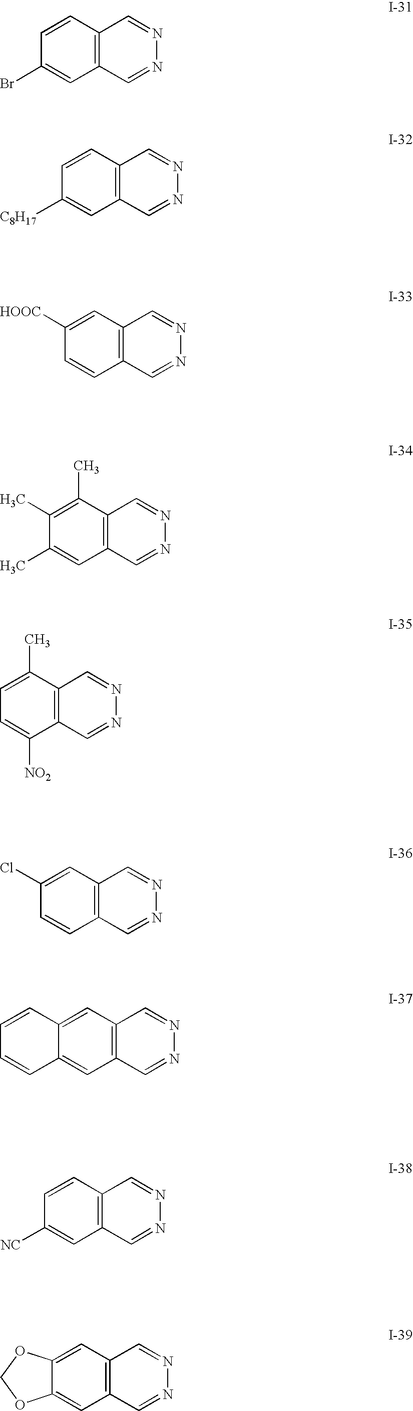

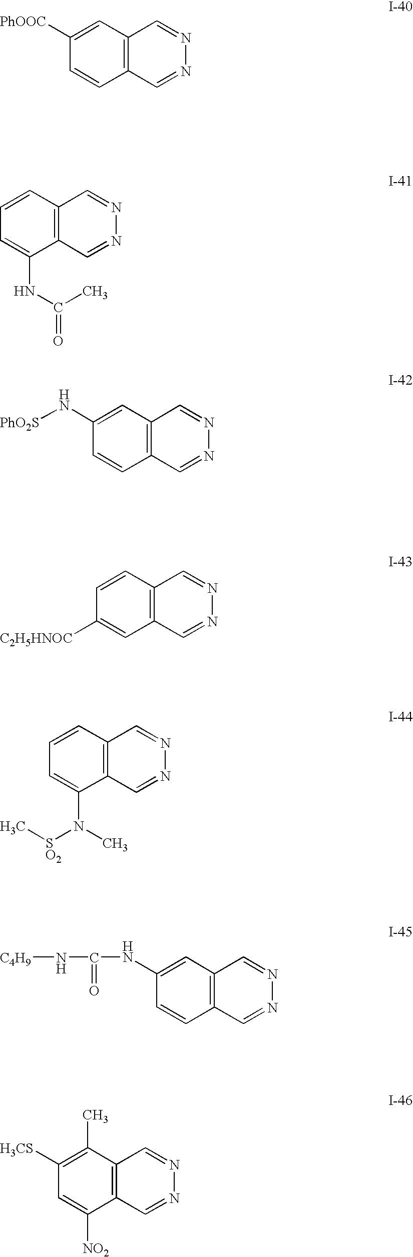

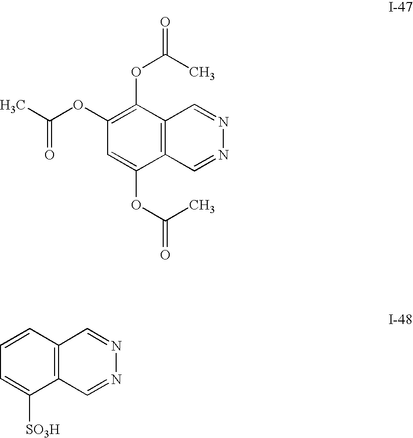

In the invention, a phthalic acid compound represented by the following gel (II) is preferably used: 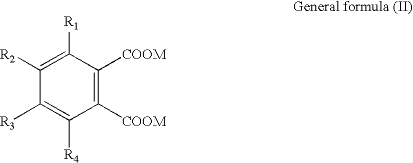
wherein each of R₁ to R₄ independently represents a hydrogen atom or a monovalent substituent, and when three out of R₁ to R₄ are hydrogen atoms, a remaining monovalent substituent is a group other than a methyl group; and M represents a hydrogen atom, an alkali metal, an alkali earth metal, an ammonium group, or a phosphonium group.

The monovalent substituent is selected from the same groups as described as the substituent of W₁ to W₄.

The following will illustrate typical examples of the compound represented by the general formula (II) in the invention. In the invention, however, the compound is not limited to these examples. 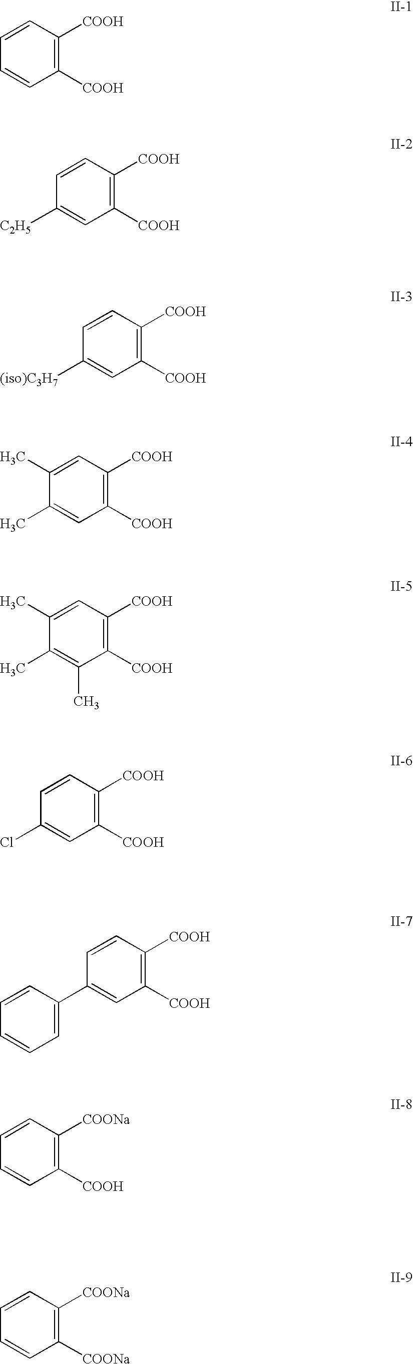 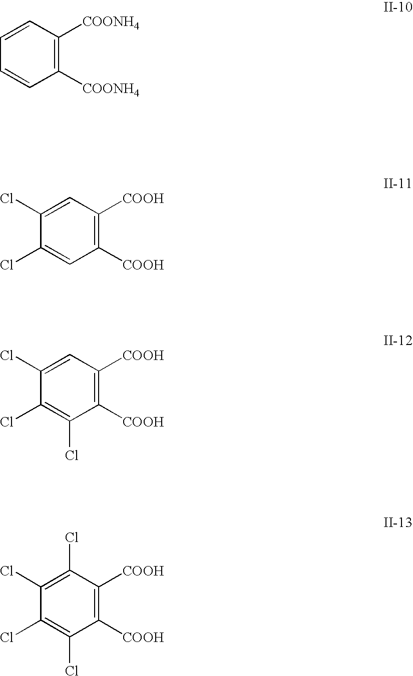
Description of a Development Promoter

In the photothermographic material of the invention, it is preferred to use, as a development promoter, a sulfonamide phenol type compound represented by the general formula (A) described in JP-A No. 2000-267222 or 2000-330234, a hindered phenol type compound represented by the general formula (II) described in JP-A No. 2001-92075, a hydrazine type compound represented by the general formula (I) described in JP-A No. 10-62895 or 11-15116, the general formula (D) described in JP-A No. 2001-156727, or general formula (1) described in Japanese Patent Application No. 2001-074278, or a phenol type or naphthol type compound represented by the general formula (2) described in JP-A No. 2001-264929. The amount of such a development promoter is from 0.1 to 20%, preferably from 0.5 to 10% and more preferably from 1 to 5% by mole of the reducing agent. The method of introducing the development promoter into the photosensitive material is the same as the method of introducing the reducing agent thereinto. It is particularly preferred that the development promoter is added thereto in the form of a solid dispersion or an emulsion dispersion. In the case that the development promoter is added in the form of an emulsion dispersion, it is preferred that the promoter is added in the form of an emulsion dispersion in which the promoter is dispersed in a high boiling point solvent, which is in a solid state at ambient temperature, and a low boiling point cosolvent, or the promoter is added in the form of the so-called oilless emulsion dispersion, in which no high boiling point is used.

In the invention, more preferred are hydrazine type compounds represented by the general formula (D) described in JP-A No. 2002-156727 and phenol or naphthol type compounds represented by the general formula (2) described in JP-A No. 2001-264929.

A particularly preferred example of the development promoter in the invention is a compound represented by the following general formula (A-1) or (A-2):
Q₁—NHNH—Q₂ General formula (A-1)
wherein Q₁ represents an aromatic group or a heterocyclic group bonded to —NHNH—Q₂ at its carbon atom wherein Q₂ represents a carbamoyl, acyl, alkoxycarbonyl, aryloxycarbonyl, sulfonyl or sulfamoyl group.

In the general formula (A-1), the aromatic group or the heterocylic group represented by Q₁ is preferably a 5-membered to 7-membered unsaturated ring. Preferred examples of the ring include benzene, pyridine, pyrazine, pyrimidine, pyridazine, 1,2,4-triazine, 1,3,5-triazine, pyrrole, imidazole, pyrazole, 1,2,3-triazole, 1,2,4-triazole, tetrazole, 1,3,4-thiadiazole, 1,2,4-thiadiazole, 1,2,5-thiadiazole, 1,3,4-oxadiazole, 1,2,4-oxadiazole, 1,2,5-oxadiazole, thiazole, oxazole, isothiazole, isooxazole, and thiphene rings. Condensed rings in which these rings are condensed are also preferred.

These rings may have a substituent. When the rings have two or more substituents, the substituents may be the same or different. Examples of the substituent include halogen atoms, and alkyl, aryl, carbonamide, alkylsulfonamide, arylsulfonamide, alkoxy, aryloxy, alkylthio, arylthio, carbamoyl, sulfamoyl, cyano, alkylsulfonyl, arylsulfonyl, alkoxycarbonyl, aryloxycarbonyl, and acyl groups. When these substituents are groups which can be substituted, the substituents further have a substituent. Preferred examples of the substituent include halogen atoms, and alkyl, aryl, carbonamide, alkylsulfonamide, arylsulfonamide, alkoxy, aryloxy, alkylthio, arylthio, acyl, alkoxycarbonyl, aryloxycarbonyl, carbamoyl, cyano, sulfamoyl, alkylsulfonyl, arylsulfonyl, and acyloxy groups.

The carbamoyl group represented by Q₂ is a carbamoyl group which preferably has 1 to 50 carbon atoms and more preferably has 6 to 40 carbon atoms. Examples thereof include non-substituted carbamoyl, methylcarbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl)carbamoyl, N-(2chloro-5-dodecyloxycarbonylphenyl)carbamoyl, N-naphthylcarbamoyl, N-3-pyridinecarbamoyl, and N-benzylcarbamoyl.

The acyl group represented by Q₂ is an acyl group which preferably has 1 to 50 carbon atoms and more preferably has 6 to 40. Examples thereof include formyl, acetyl, 2-methylpropanoyl, cyclohexylcarbonyl, octanoyl, 2-hexyldecanoyl, dodecanoyl, chloroacetyl, trifluroacetyl, benzoyl, 4-dodecyloxybenzoyl, and 2-hydroxymethylbenzoyl groups. The alkoxycarbonyl group represented by Q₂ is an alkoxycarbonyl group which preferably has 2 to 50 and more preferably has 6 to 40. Examples thereof include methoxycarbonyl, ethoxycarbonyl, isobutyloxycarbonyl, cyclohexyloxycarbonyl, dodecyloxycarbonyl and benzyloxycarbonyl groups.

The aryoxycarbonyl group represented by Q₂ is an aryloxycarbonyl group which preferably has 7 to 50 carbon atoms and more preferably has 7 to 40 carbon atoms. Examples thereof include phenoxycarbonyl, 4-octyloxyphenoxycarobonyl, 2-hydroxymethylphenoxycarbonyl, and 4-dodecyloxyphenoxycarbonyl groups. The sulfonyl group represented by Q₂ is a sulfonyl group which preferably has 1 to 50 carbon atoms and more preferably has 6 to 40 carbon atoms. Examples thereof include methylsulfonyl, butylsulfoyl, octylsulfonyl, 2-hexadecylsulfonyl, 3-dodecyloxypropylsulfonyl, 2-octyloxy-5-tertoctylphenylsulfonyl and 4-dodecyloxyphenylsulfonyl groups.

The sulfamoyl group represented by Q₂ is a sulfamoyl group which preferably has 0 to 50 carbon atoms and more preferably has 6 to 40 carbon atoms. Examples thereof include non-substituted sulfamoyl, N-ethylsulfamoyl, N-(2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbonylphenyl)sulfamoyl, and N-(2-tetradecyloxyphenyl)sulfamoyl groups. The group represented by Q₂ may has, at a position or positions capable of having a substituent, one or more selected from the groups described as examples of the substituent of the 5-membered to 7-membered unsaturated ring represented by Q₁. When the group represented by Q₂ has two or more substituents, they may be the same or different.

The following will describe preferred compounds represented by the formula (A-1). Q₁ is preferably a 5-membered or 6-membered unsaturated ring, and is more preferably a benzene, pyrimidine, 1,2,3-triazole, 1,2,4-triazole, tetrazole, 1,3,4-thiadiazole, 1,2,4-thiadiazole, 1,3,4-oxadiazole, 1,2,4-oxadiazole, thiazole, oxazole, isothiazole, isooxazole, or a ring wherein any one of these rings is condensed with a benzene ring or an unsaturated hetero ring. Q₂ is preferably a carbamoyl group, and is more preferably a carbamoyl group having, on its nitrogen atom, a hydrogen atom.

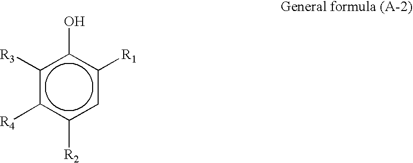

In the general formula (A-2), R₁ represents an alkyl, acyl, acylamino, sulfonamide, alkoxycarbonyl, or carbamoyl group. R₂ represents a hydrogen or halogen atom, or an alkyl, alkoxy, aryloxy, alkylthio, arylthio, acyloxy or carbonic ester group. R₃ and R₄ each independently represent a group which can be substituted on the benzene ring and is any one selected from the groups described as examples of the substituent of the compound represented by the general formula (A-1). R₃ and R₄ may be bonded to each other to form a condensed ring.

R₁ is preferably an alkyl group which preferably has 1 to 20 carbon atoms (such as a methyl, ethyl, isopropyl, butyl, tert-octyl or cyclohexyl group), an acylamino group (such as an acetylamino, benzoylamino, methylureido, or 4-cyanophenylureido group), or a carbamoyl group (such as a n-butylcarbamoyl, N,N-diethylcarbamoyl, phenylcarbamoyl, 2-chlorophenylcarbamoyl, or 2,4-dichlorophenylcarbamoyl group), and is more preferably an acylamino group, the category of which include ureido and urethane groups. R₂ is preferably a halogen atom (more preferably a chlorine or bromine atom), an alkoxy group (such as a methoxy, butoxy, n-hexyloxy, n-decyloxy, cyclohexyloxy or benzyloxy group), or an aryloxy group (such as a phenoxy or naphthoxy group). R₃ is preferably a hydrogen atom, a halogen atom, or an alkyl group having 1 to 20 carbon atoms, and is more preferably a halogen atom. R₄ is preferably a hydrogen atom, an alkyl group or an acylamino group, and is more preferably an alkyl group or an acylamino group. Examples of a preferred substituent of these groups are the same as R₁. When R₄ is an acylamino group, it is also preferred that R₄ and R₃ are linked to each other to form a carbostyryl ring.

When R₃ and R₄ in the general formula (A-2) are linked to each other to form a condensed ring, the condensed ring is particularly preferably a naphthalene ring. A substituent equal to any one of the examples of the substituent described about the general formula (A-1) may be bonded to the naphthalene ring. When the general formula (A-2) represents a naphthol type compound, R₁ is preferably a carbamoyl group. R₁ is particularly preferably a benzoyl group. R₂ is preferably an alkoxy or aryloxy group, and is particularly preferably an alkoxy group.

The following will illustrate preferred specific examples of the development promoter in the invention. However, in the invention, the development promoter is not limited to these examples. 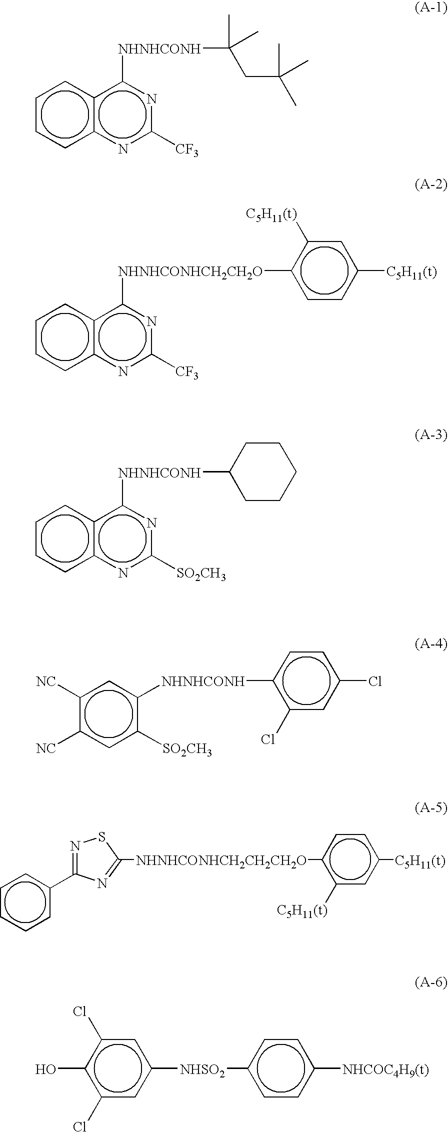 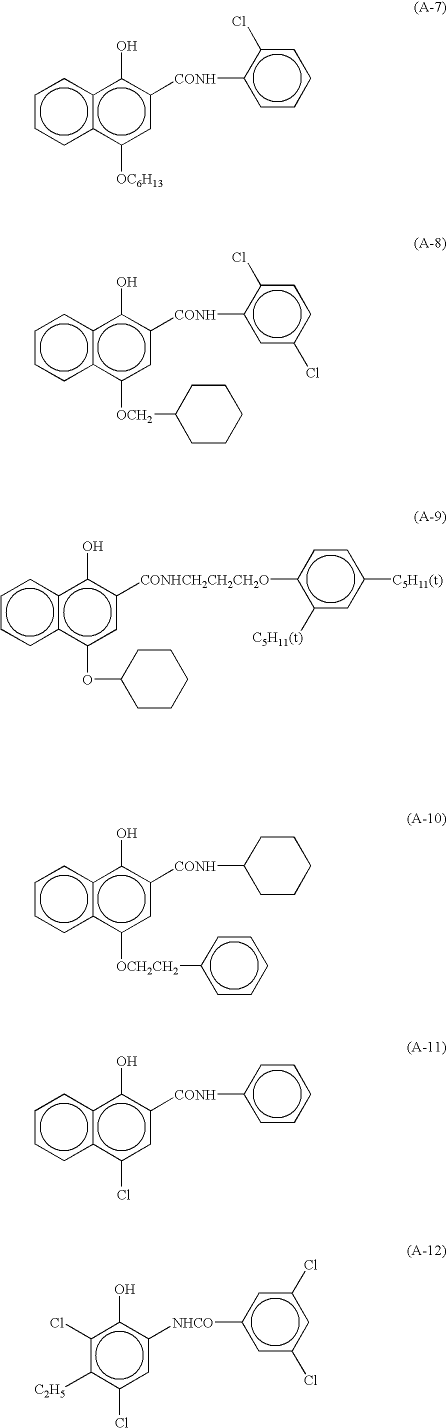
Description on a Hydrogen-Bonding Compound

When the reducing agent in the invention has an aromatic hydroxyl group (—OH) or amino group, in particular, when the reducing agent is the above-mentioned bisphenol compound, it is preferred that a non-reducing compound having a group capable of forming a hydrogen bond with the hydroxyl or amino group is together used. Examples of the group capable of forming a hydrogen bond with the hydroxyl or amino group include phosphoryl, sulfoxide, sulfonyl, carbonyl, amide, ester, urethane, ureido, tertiary amino, and nitrogen-containing aromatic groups. Preferred are compounds having a phosphoryl group, a sulfoxide group, an amide group(the amide group having no >N—H group and having a blocked group such as >N—Ra wherein Ra is a substituent other than H), a urethane group (the urethane group having no >N—H group and having a blocked group such as >N—Ra wherein Ra is a substituent other than H), or a ureido group (the ureido group having no >N—H group and having a blocked group such as >N—Ra wherein Ra is a substituent other than H)

The hydrogen-bonding compound in the invention is particularly preferably a compound represented by the following general formula (D):

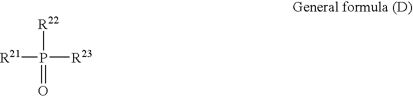

In the general formula (D), R₂₁ to R₂₃ each independently represent an alkyl, aryl, alkoxy, aryloxy, amino or heterocyclic group, each of which may have a substituent or no substituent. When R₂₁ to R₂₃ have a substituent, examples of the substituent include halogen atoms, and alkyl, aryl, alkoxy, amino, acyl, acylamino, alkylthio, arylthio, sulfonamide, acyloxy, oxycarbonyl, carbamoyl, sulfamoyl, sulfonyl, and phosphoryl groups. The substituent is preferably an alkyl or aryl group, specific examples of which include methyl, ethyl, isopropyl, t-butyl, t-octyl, phenyl, 4-alkoxyphenyl, and 4-acyloxyphenyl groups.

Specific examples of the alkyl group as each of R₂₁ to R₂₃ includes methyl, ethyl, butyl, octyl, dodecyl, isopropyl, t-butyl, t-amyl, t-octyl, cyclohexyl, 1-methylcyclohexyl, benzyl, phenethyl, and 2-phenoxypropyl groups. Specific examples of the aryl group include phenyl, cresyl, xylyl, naphthyl, 4-t-butylpehnyl, 4-t-octylphenyl, 4-anisidyl, and 3,5-dichlorophenyl groups. Specific examples of the alkoxy group include methoxy, ethoxy, butoxy, octyloxy, 2-ethylhexyloxy, 3,5,5-trimethylhexyloxy, dodecyloxy, cyclohexyloxy, 4-methylcyclohexyloxy and benzyloxy groups. Specific examples of the aryloxy group include phenoxy, cresyloxy, isopropylphenoxy, 4-t-butylphenoxy, naphthoxy, and biphenyloxy groups. Specific examples of the amino group include dimethylamino, diethylamino, dibutylamino, dioctylamino, N-methyl-N-hexylamino, dicyclohexylamino, diphenylamino, and N-methyl-N-phenylamino group.

R₂₁ to R₂₃ are each preferably an alkyl, aryl, alkoxy or aryloxy group. From the viewpoint of the advantageous effects of the invention, at least one of R₂₁ to R₂₃ is preferably an alkyl or aryl group. More preferably, two or more thereof are alkyl or aryl groups. From the viewpoint of easy availability, R₂₁ to R₂₃ are preferably the same groups.

The following will illustrate specific examples of the hydrogen-bonding compound, including the compounds represented by the general formula (D) in the invention. However, in the invention, the hydrogen-bonding compound is not limited to these examples.

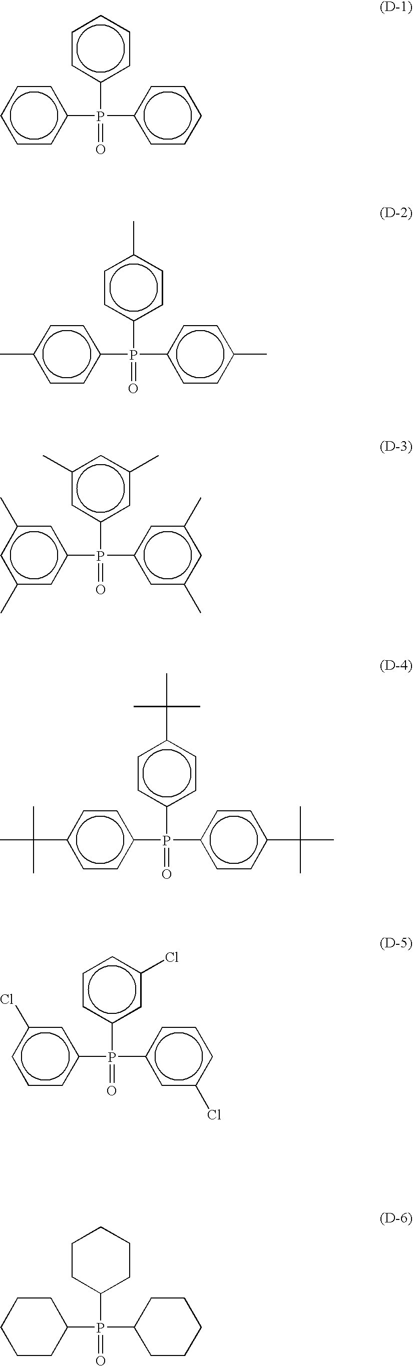

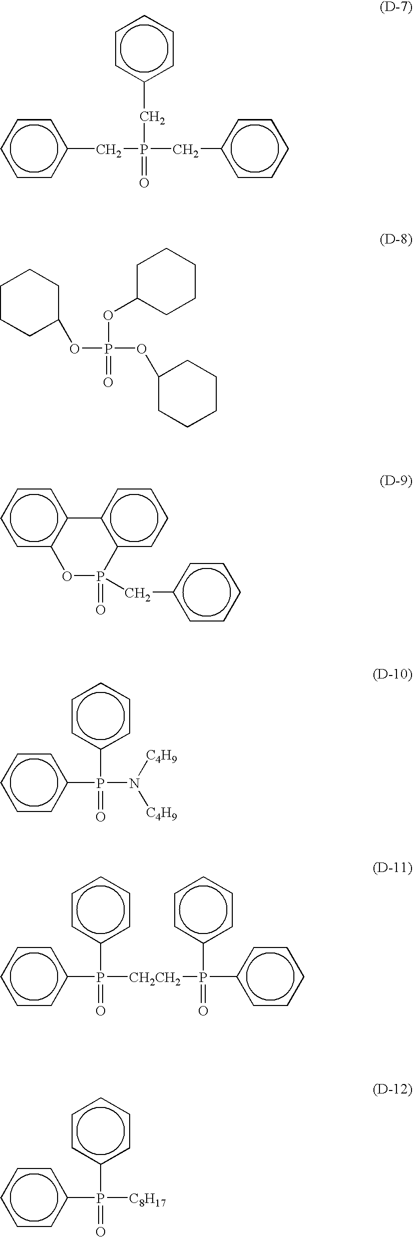

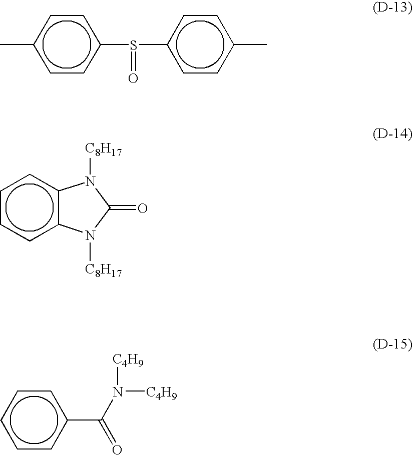

Specific examples of the hydrogen-bonding compound include compounds described in European Patent No. 1096310, JP-A No. 2002-156727, and Japanese Patent Application No. 2001-124796, as well as the compounds illustrated above.

The compound represented by the general formula (D) in the invention can be incorporated, in the form of a solution, an emulsion dispersion, or a solid fine particle dispersion, into a coating-solution, so as to be used in the photosensitive material of the invention. The compound is preferably used as a solid dispersion. The compound in the invention is combined, in a solution state, with a compound having a phenolic hydroxyl group and an amino group to make a hydrogen-bonding complex. Depending upon a combination of the selected reducing agent with the compound represented by the general formula (D) in the invention, the complex can be isolated in a crystal state. To use the thus-isolated crystal powder as a solid fine particle dispersion is particularly preferred to obtain stable performance. It is also preferred to use a method of mixing the reducing agent with the compound represented by the general formula (D) in the invention in a powder form and then using a suitable dispersing agent to form a complex by means of a sand grinder mill or the like at the time of dispersing them.

The compound represented by the general formula (D) in the invention is used preferably in an amount of 1 to 200% by mole of the reducing agent, more preferably in an amount of 10 to 150% by mole thereof, and most preferably in an amount of 20 to 100% by mole thereof.

Description of Silver Halide

The halogen composition of the photosensitive silver halide used in the invention is not particularly limited. Thus, it is possible to use silver chloride, silver chlorobromide, silver bromide, silver iodobromide, silver iodochlorobromide or silver iodide. Among these silver halides, silver bromide and silver iodobromide are preferred. The distribution of the halogen composition in each particle may be uniform or may be stepwise or continuously changed. Silver halide particles having a core/shell structure can be preferably used. The structure is preferably a twofold to fivefold structure, more preferably a twofold to fourfold structure. It is also preferred to use technique for localizing silver bromide or silver iodide in the surface of a silver halide, silver bromide, or silver chlorobromide particle.

The method for forming photosensitive silver halide is well known in the art. For example, methods described in Research Disclosure No. 17029 (June in 1978) and U.S. Pat. No. 3,700,458 maybe used. Specifically, there is used a method of adding a silver-supplying compound and a halogen-supplying compound to a solution of gelatin or a different polymer to prepare photosensitive silver halide, and then mixing the silver halide with an organic silver salt. Preferred are also methods described in JP-A No. 11-119374, paragraphs 0217 to 0224, and JP-A Nos. 11-352627 and 2000-347335.

In order to suppress cloudiness after an image is formed from the photosensitive silver halide, it is preferred that the particle size thereof is small. Specifically, the particle size is preferably 0.20 μm or less, more preferably 0.01 μm or more and 0.15 μm or less, and most preferably 0.02 μm or more and 0.12 μm or less. The particle size referred to herein means a diameter obtained by converting the projected area of a silver halide particle (in the case of a tabular particle, the projected area of the main plane thereof) to a circle image having the same area.

The shape of the silver halide particles may be cubic, octahedral, tabular, spherical, rod-shaped, potato-shaped, or the like. In the invention, cubic particles are particularly preferred. Silver halide particles the corners of which are round are also preferred. The Miller indices of the outside surfaces of the photosensitive silver halide particles are not particularly limited. It is preferred that the ratio of the [100] plane, which has a high spectral sensitization efficiency when a spectrally sensitizing dye is adsorbed thereon, is high. The ratio thereof is preferably 50% or more, more preferably 65% or more, and most preferably 80% or more. The ratio of the Miller indices [100] plane can be obtained by the method described in T. Tani, J. Imaging Sci,. 29, 165 (1985), using the adsorption dependency of the [111] plane and the [100] plane in the adsorption of a sensitizing dye.

The photosensitive silver halide particles in the invention can contain metals in the 8 to 10 groups in the periodic table (showing the 1 to 18 groups), or complexes of the metals. The metals in the 8 to 10 groups in the periodic table and central metals of the metal complexes are preferably rhodium, ruthenium, and iridium. These metal complexes may be used alone, or two or more complexes of the same metal or different metals may be used. The content of the metal(s) or metal complex(es) is preferably from 1×10⁻⁹ to 1×10⁻³ mole per mole of silver. These heavy metals and metal complexes, and the method of the addition thereof are described in JP-A Nos. 7-225449, 11-65021 paragraphs 0018 to 0024, and JP-A No. 11-119374, paragraphs 0227 to 0240.

In the invention, silver halide particles wherein a hexacyano metal complex is caused to be present on the outermost surface thereof are preferred. Examples of the hexacyano metal complex include [Fe(CN)₆]⁴⁻, [Fe(CN)₆]³⁻³, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻. In the invention, hexacyano Fe complexes are preferred.

Since the hexacyano metal complexes are present in an ion form in aqueous solution thereof, a counter cation thereof is not important. Preferably, there are used ions which are easily miscible with water and suitable for precipitation operation of silver halide emulsion, specific examples of which include alkali metal ions (such as sodium, potassium, rubidium, cesium and lithium ions), an ammonium ion, and alkylammonium ions (such as a tetramethylammonium ion, a tetraethylammonium ion, a tetrapropylammonium ion, and a tetra(n-butyl)ammonium ion).

The hexacyano metal complex is mixed with a mixed solvent of water and a suitable organic solvent miscible with water (such as an alcohol, an ether, a glycol, a ketone, an ester, an amide or the like), or with gelatin, so as to be added to the silver halide preparing solution.

The adding amount of the hexacyano metal complex is preferably from 1×10⁻⁵ to 1×10⁻² mole (inclusive), more preferably from 1×10⁻⁴ to 1×10⁻³ mole (inclusive) per mole of silver.

In order to cause the hexacyano metal complex to be present in the outermost surfaces of the silver halide particles, the hexacyano metal complex is directly added to the silver halide preparing solution after the end of addition of an aqueous silver nitrate solution used for the formation of particles and before the step of chemical sensitization for performing calcogen sensitization such as sulfur sanitization, selenium sensitization or tellurium sensitization or noble metal sensitization such as gold sensitization, that is, before the end of the so-called charging step, during the water-washing step, during the dispersing step, or before the chemical sensitization step. In order not to cause the silver halide fine particles to grow, it is preferred that the hexacyano metal complex is rapidly added to the silver halide preparing solution after the formation of the particles and before the end of the charging step.

The addition of the hexacyano metal complex is started preferably after the end of the addition of 96% by mass of the total amount of silver nitrate added to form the particles, preferably after the end of the addition of 98% by mass thereof, and most preferably after the end of the addition of 99% by mass thereof.

When the hexacyano metal complex is added to the silver halide preparing solution after the addition of the aqueous silver nitrate solution, the addition being immediately before the completion of the formation of the particles, the hexacyano metal complex can be adsorbed on the outermost surfaces of the silver halide particles so that almost all thereof is bonded to silver ions on the particle surfaces to forms lightly-soluble salts. The silver salt of hexacyano iron (II) is a more slightly soluble salt than AgI; therefore, the re-dissolution of the salt, based on finer particles, can be prevented and silver halide fine particles having a smaller particle size can be produced.

A metal atom (such as [Fe(CN)₆]⁴⁻) which the silver halide particles used in the invention can contain, and the desalting method of silver halide emulsion, and chemical sensitization are described in JP-A No. 11-84574, paragraphs 0046 to 0050, JP-A No. 11-65021, paragraphs 0025 to 0031, and JP-A No. 11-119374, paragraphs 0242 to 0250.

As the gelatin contained in the photosensitive silver halide emulsion used in the invention, various gelatins can be used. Since it is necessary to keep the dispersion state of the gelatin in the photosensitive silver halide emulsion coating-solution which contains the organic silver salt satisfactorily, it is preferred to use a gelatin having a molecular weight of 10,000 to 1,000,000. It is also preferred to subject a substituent of the gelatin to phthalating treatment. Such a gelatin may be used at the time of forming the particles or at the time of dispersing the particles after desalting treatment, and is preferably used at the time of forming the particles.

The sensitizing dye which can be used in the invention is a dye making it possible to sensitize the silver halide particles spectrally within a desired wavelength range when the dye is adsorbed on the silver halide particles, and can be favorably selected from sensitizing dyes having a spectral sensitivity suitable for the spectral characteristic of a light source for exposure. The sensitizing dye and the adding method thereof are described in JP-A No. 11-65021, paragraphs 0130 to 0109, JP-A No. 10-186572 (compounds represented by the general formula (II)), JP-A No. 11-119374 (dyes represented by the general formula (I)), paragraphs 0106, U.S. Pat. No. 5,510,236, U.S. Pat. No. 3,871,887 (dyes described in Example 5), JP-A Nos. 2-96131, 59-48753, EP-A1 No. 0803764, page 19, line 38 to page 20, line 35, and JP-A Nos. 2001-272747, 2001-290238 and 2002-23306. These sensitizing dyes may be used alone or in combination of two or more thereof. The time when the sensitizing dye is added to the silver halide emulsion in the invention is preferably a period after the so-called desalting step and before the application of the emulsion, more preferably a period after the desalting step and before the end of chemical ripening.

The adding amount of the sensitizing dye in the invention, which may be set to a desired amount in accordance with the sensitivity or fogging performance of the photosensitive layer, is preferably from 10⁻⁶ to 1 mole, more preferably from 10⁻⁴ to 10⁻¹ mole per mole of silver halide in the photosensitive layer.

In order to improve the spectrally sensitizing efficiency in the invention, a supersensitizer can be used. Examples of the supersensitizer used in the invention include compounds described in EP-A No. 587,338, U.S. Pat. Nos. 3,877,943 and 4,873,184, the disclosures of which are incorporated by reference herein and JP-A Nos. 5-341432, 11-109547, and 10-111543.

The photosensitive silver halide particles in the invention are preferably chemically sensitized by sulfur sensitization, selenium sensitization or tellurium sensitization. A compound which is preferably used in the sulfur sensitization, selenium sensitization or tellurium sensitization may be a known compound, examples of which are described in JP-A No. 7-128768. In the invention, tellurium sensitization is particularly preferred. Compounds described in JP-A No. 11-65021, paragraph 0030 and compounds represented by the general formula (II), (III) or (IV) in JP-A No. 5-313284 are preferably used.

The photosensitive silver halogen particles in the invention are preferably subjected to only chemical sensitization by gold sensitization or to chemical sensitization by gold sensitization in combination with the above-mentioned calcogen sensitization. In a gold sensitizer in this case, the valence of the gold therein is preferably +1 or +3. As the gold sensitizer, gold compounds which are usually used are preferred. Typical examples thereof include chloroauric acid, bromoauric acid, potassium chloroaurate, potassium bromoaurate, auric trichloride, potassium auric thiocyanate, potassium iodoaurate, tetracyanoauric acid, ammonouim aurothiocyanate, and pyridyltrichlorogold. Gold sensitizers described in U.S. Pat. No. 5,858,637 and Japanese Patent Application No. 2001-79450 are also preferred.

In the invention, the chemical sensitization may be performed at any timing after the formation of the particles and before the application thereof. The timing may be after desalting and (1) before spectral sensitization, (2) the same time of the spectral sensitization, (3) after the spectral sensitization, or (4) immediately before the application.

The amount of the sulfur, selenium or tellurium sensitizer used in the invention, which varies depending on the kind of the used silver halide particles, chemical ripening conditions thereof and so on, is from about 10⁻⁸ to 10⁻² mole, preferably from about 10⁻⁷ to 10⁻³ mole per mole of the silver halide. The adding amount of the gold sensitizer, which varies depending on various conditions, is typically from 10⁻⁷ to 10⁻³, preferably from 10⁻⁶ to5×10⁻⁴ mole per mole of the silver halide.

In the invention, conditions for the chemical sensitization are not particularly limited. Typically, the pH is from 5 to 8, the pAg is from 6 to 11, and the temperature is from about 40 to 95° C.

It is allowable to add, to the silver halide emulsion used in the invention, a thiosulfonic acid compound by the method described in EP-A No. 293,917.

It is preferred to apply reducing sensitization in the photosensitive silver halide particles in the invention. Specific and preferred examples of a compound used in the reducing sensitization include ascorbic acid, thiourea dioxide, tin dichloride, aminoiminomethanesulfinic acid, hydrazine derivatives, borane compounds, silane compounds, and polyamine compounds. The addition of the reducing sensitizer may be performed at any stage in the photosensitive emulsion producing process from the step of crystal grow to the step of preparation of the emulsion immediately before application thereof. It is preferred that the reducing sensitization is performed by ripening the emulsion while keeping the pH of the emulsion at 7 or more or the pAg thereof at 8.3 or less. It is also preferred that the reducing sensitization is performed by the introduction of the single addition portion of silver ions during the formation of the particles.

It is preferred that the photosensitive silver halide emulsion in the invention contains a fragmentable electron donating sensitizer (FED sensitizer) as a compound which generates two electrons by one photon. Preferred examples of the FED sensitizer are compounds described in U.S. Pat. Nos. 5,747,235, 5,747,236, 6,054,260, and 5,994,051, the disclosures of which are incorporated herein by reference and Japanese Patent Application No. 2001-86161. The addition of the FED sensitizer may be performed at any stage in the photosensitive emulsion producing process from the step of crystal grow to the step of preparation of the emulsion immediately before application thereof. The adding amount thereof, which varies depending on various conditions, is typically from 10⁻⁷ to 10⁻¹ mole, preferably from 10⁻⁶to 5×10⁻²mole per mole of the silver halide.

About the photosensitive silver halide emulsions in the photosensitive material used in the invention, one kind thereof may be used, or two or more kinds thereof (for example, emulsions different in average particle size, halogen composition, crystal habit or chemical sensitization conditions) may be used. The gray scale can be adjusted using plural kinds of silver halides having different sensitivities. Such techniques are described in JP-A No. 57-119341, 53-106125, 47-3929, 48-55730, 46-5187, 50-73627, 57-150841. It is preferred that the difference in sensitivity between the respective emulsions is set to 0.2 logE or more.

The adding amount of the photosensitive silver halide is preferably from 0.03 to 0.6 g/m², more preferably from 0.05 to 0.4 g/m², and most preferably from 0.07 to 0.3 g/m² (on the basis of the weight of coated silver) per square meter of the photosensitive material. The amount of the photosensitive silver halide is preferably from 0.01 to 0.5 mole, more preferably from 0.02 to 0.3 mole, and most preferably from 0.03 to 0.2 mole per mole of the organic silver salt.

For mixing the photosensitive silver halide and the organic silver salt which are separately prepared, and conditions for the mixing, there are several known methods of mixing the photosensitive silver halide and the organic silver salt which are separately prepared by means of a high-speed stirring machine, a ball mill, a sand mill, a colloid mill, a vibration mill, a homogenizer or the like; a method of mixing the photosensitive silver halide salt which has already been prepared with the organic silver halide which is being prepared, the mixing being performed at any stage during the preparation of the organic silver halide, so as to complete the organic silver salt; and other techniques. The type of method which can be used is not particularly limited as long as the advantageous effects of the invention are sufficiently produced. For the adjustment of a photographic property to be obtained, it is preferred to mix two or more kinds of organic silver salts dispersed in aqueous solutions with two or more kinds of photosensitive silver salt dispersed in aqueous solutions.

The timing of adding the silver halide to the image forming layer coating-solution in the invention is preferably from a time before 180 minutes from the application of the solution to a time immediately before the application, more preferably from a time before 60 minutes from the application to a time before 10 seconds therefrom. The method and conditions for the mixing in this case are not particularly limited as long as the advantageous effects of the invention are sufficiently produced. Specific examples of the mixing method include a method of mixing them in a tank wherein an average solution-residence time obtained by calculation from the flow rate of an added solution and the solution amount supplied to a coater is set to a desired time; or a method of using a static mixer described in Chapter 8 in “Liquid Mixing Technique”, written by N. Harnby, M. F. Edwards and A. W. Nienow, translated by Koji Takahashi, and published by the Nikkan Kogyo Shimbun, Ltd. in 1989.

Description of the Binder

The binder in the organic silver containing layer in the invention may be any polymer. The binder is preferably a binder which is transparent or nontransparent, is generally colorless, and is made of a natural resin (polymer or copolymer), a synthetic resin (polymer or copolymer), or some other film-making medium. Examples thereof include gelatins, rubbers, poly(vinylalcohol) compounds, hydroxyethylcellulose compounds, cellulose acetate compounds, cellulose acetate butyrate compounds, poly(vinylpyrrolidone) compounds, casein, starch, poly(acrylic acid) compounds, poly(methyl methacrylate) compounds, poly(vinyl chloride) compounds, poly(methacrylic acid) compounds, styrene/maleic anhydride copolymers, styrene/acrylonitrile copolymers, styrene/butadiene copolymers, poly(vinylacetal) compounds (such as poly(vinylformal) and poly(vinylbutyral)), poly(ester) compounds, poly(urethane) compounds, phenoxy resins, poly(vinylidene chloride) compounds, poly(epoxide) compounds, poly(carbonate) compounds, poly(vinyl acetate) compounds, poly(olefin) compounds, cellulose ester compounds, and poly(amide) compounds. The binder may be formed into a coating from water, an organic solvent or an emulsion.

In the invention, the glass transition temperature (Tg) of the binder used in the organic silver salt containing layer is preferably 0° C. or higher and 80° C. or lower. This binder may be referred to as the high Tg binder hereinafter. The glass transition temperature is more preferably from 10 to 70° C., most preferably from 15 to 60° C.

In the present specification, the Tg of the binder polymer is calculated from the following equation:
1/Tg=Σ(Xi/Tgi)

It is supposed that the polymer is a copolymer made from monomer components, the number of which is n (i.e., i=1 to n). Xi represents the weight fraction of the i^{th} monomer (ΣXi=1). Tgi represents the glass transition temperature (absolute temperature) of the homopolymer made from the i^{th} monomer. The symbol Σ represents the summation of from the i^{st} component to the i^{th} component. As the value (Tgi) of the glass transition temperature of the homopolymer made of each monomer, a value described in “Polymer Handbook (3^{rd} Edition)” written by J. Brandrup and E. H. Immergut, and published by Wiley-Interscience in 1989 is adopted.

If desired, two or more binders may be used together. It is allowable to use a combination of a binder having a glass transition temperature of 20° C. or higher with a binder having a glass transition temperature of less than 20° C. When two or more polymers having different Tg's are blended and used, it is preferred that the weight-average Tg thereof falls within the above-mentioned range.

In the invention, it is preferred to apply a coating-solution the solvent of which contains 30% by mass or more of water and then dry the applied solution to form a coating membrane, thereby forming the organic silver salt containing layer.

In the above-mentioned case, the performance of the organic silver salt containing layer is improved when the binder in the organic silver salt containing layer is soluble or dispersible in an aqueous solvent (water solvent), in particular, when the binder is made of a latex of a polymer having an equilibrium water content (at 25° C. and 60% RH) of 2% by mass or less. Most preferably, the coating-solution is prepared in such a manner that the ion conductivity thereof is 2.5 mS/cm or less. An example of such a preparing method is a method of using a separating functional membrane after the synthesis of the polymer to purify the polymer.

The aqueous solvent in which the above-mentioned polymer is soluble or dispersible is water, or a mixed solvent wherein water is mixed with 70% by weight or less of an organic solvent miscible with water. Examples of the organic solvent miscible with water include alcohols such as methyl alcohol, ethyl alcohol, and propyl alcohol; cellosolves such as methylcellosolve, ethylcellosolve, and butylcellosolve; ethyl acetate; and dimethylformamide.

Herein, the wording “the aqueous solvent” also represents a system wherein the polymer is not thermodynamically dissolved and is present in the so-called dispersed state.

The “equilibrium water content (at 25° C. and 60% RH)” of a polymer can be represented by the following equation:
Equilibrium water content (at 25° C. and 60% RH) (unit: %)=[W₁−WO)/WO]×100 (% by mass)
wherein W₁ represents the weight of the polymer in an air conditioning equilibrium state at 25° C. and 60% RH and WO represents the weight of the polymer in a completely dry state at 25° C.

About the definition of the water content and the measuring method thereof, for example, “Polymer Engineering Lecture 14, Polymer Material Test Method” (edited by the Society of Polymer Science, Japan, and published by Chijinshokan Co., Ltd.) can be referred to.

The equilibrium water content (at 25° C. and 60% RH) of the binder polymer in the invention is preferably 2% by mass or less, more preferably 0.01% or more and 1.5% by mass or less, and most preferably 0.02% or more and 1% by mass or less.

In the invention, the binder is particularly preferably a polymer dispersible in the aqueous solvent. Examples of a product wherein the polymer is dispersed include a latex wherein particles of a water-insoluble hydrophobic polymer are dispersed, and a product wherein polymer molecules are dispersed in a molecular state or in a micelle-formed state. The latex is preferred. The average particle size of the dispersed particles is from 1 to 50000 nm, preferably from 5 to1000 nm, more preferably from10 to500 nm, and most preferably from 50 to 200 nm. The particle size distribution of the dispersed particles is not particularly limited. Thus, the dispersed particles may have a wide particle size distribution or a monodispersive particle size distribution. In order to control physical properties of the coating-solution, it is preferred to mix particles of two or more kinds each having a monodispersive particle size distribution.

Preferred examples of the polymer dispersible in the aqueous solvent in the invention include hydrophobic polymers such as acryl based polymers, poly(ester) compounds, rubbers (for example, SBR resin), poly(urethane) compounds, poly(vinyl chloride) compounds, poly(vinyl acetate) compounds, poly(vinylidene chloride) compounds, and poly(olefin) compounds. These polymers may be linear polymers, branched polymers, crosslinked polymers, or homopolymers, which are made by polymerization of a single monomer, or copolymers, which are made by polymerization of two or more monomers. In the case of the copolymers, the copolymers may be random copolymers or block copolymers. The number-average molecular weight of these polymers is generally from 5000 to 1000000, preferably from 10000 to 200000. The polymer the molecular weight of which is too small gives insufficient mechanical strength to the emulsion layer. The polymer the molecular weight of which is too large has bad film-forming ability. Crosslinking polymer latex is particularly preferably used.

Specific Examples of the Latex

Specific and preferred examples of the polymer latex will be listed up below. These examples are represented by starting monomers. The unit of values in parentheses is “% by mass”, and molecular weights are number-average molecular weights. When polyfunctional monomers are used, the concept of molecular weight cannot be used for the resultant polymer since the monomers form crosslinked structure. Thus, in such a case, the word “crosslinked” is described and any description on molecular weight is omitted. Tg represents glass transition temperature.
P-1: latex of -MMA(70)-EA(27)-MAA(3)-(molecularweight: 37000, Tg:61° C.),
P-2: Latex of -MMA(70)-2EHA(20)-St(5)-AA(5)-(molecular weight: 40000, Tg: 59° C.),
P-3: Latex of -St(50)-Bu(47)-MAA(3)-(crosslinked, Tg: −17° C.),
P-4: Latex of -St(68)-Bu(29)-AA(3)-(crosslinked, Tg: 17° C.),
P-5: Latex of -St(71)-Bu(26)-AA(3)-(crosslinked , Tg: 24° C.),
P-6: Latex of -St(70)-Bu(27)-IA(3)-(crosslinked),
P-7: Latex of -St(75)-Bu(24)-AA(1)-(crosslinked, Tg: 29° C.),
P-8: Latex of -St(60)-Bu(35)-DVB(3)-MAA(2) (crosslinked),
P-9: Latex of -St(70)-Bu(25)-DVB(2)-AA(3) (crosslinked),
P-10: Latex of -VC(50)-MMA(20)-EA(20)-AN(5)-AA(5)-(molecular weight: 80000),
P-11: Latex of -VDC(85)-MMA(5)-EA(5)-MAA(5)-(molecular weight: 67000),
P-12: Latex of -Et(90)-MAA(10)-(molecular weight: 12000),
P-13: Latex of -St(70)-2EHA(27)-AA(3)-(molecular weight: 130000, Tg: 43° C.),
P-14: Latex of -MMA(63)-EA(35)-AA(2)-(molecular weight: 33000, Tg: 47° C.),
P-15: Latex of -St(70.5)-Bu(26.5)-AA(3)-(crosslinked, Tg: 23° C.), and
P-16: Latex of -St(69.5)-Bu(27.5)-AA(3)-(crosslinked, Tg: 20.5° C.).

Abbreviations in the above-mentioned structures represent the following monomers. MMA: methyl methacrylate, EA: ethyl acrylate, MAA: methacrylic acid, 2EHA: 2-ethylhexyl acrylate, St: styrene, Bu: butadiene, AA: acrylic acid, DVB: divinylbenzene, VC: vinyl chloride, AN: acrylonitrile, VDC: vinylidene chloride, Et: ethylene, and IA: itaconic acid.

The above-mentioned polymer latexes are also commercially available. Polymer as follow can be used. Examples of the acryl based polymer include CEBIANs A-4635, 4718 and 4601 (all trade names, manufactured by Daicel Chemical Industries, Ltd.); and Nipol Lx's 811, 814, 821, 820 and 857 (all trade names, manufactured by Nippon Zeon Co., Ltd.). Examples of the poly(ester) compounds include FINTEX ES's 650, 611, 675 and 850 (all trade names, manufactured by Dainippon Ink & Chemicals, Inc.); and WD-size and WMS (all trade names, manufactured by Eastman Chemical Co.). Examples of the poly(urethane) compounds include HYDRAN AP's 10, 20, 30 and 40 (all trade names, manufactured by Dainippon Ink & Chemicals, Inc.). Examples of the rubbers include LACSTARs 7310K, 3307B, 4700H, and 7132C (all trade names, manufactured by Dainippon Ink & Chemicals, Inc.); and Nipol Lx's 416, 410, 438C and 2507 (all trade names, manufactured by Nippon Zeon Co., Ltd.). Examples of the poly(vinyl chloride)compounds include G351 and G576 (all trade names, manufactured by Nippon Zeon Co., Ltd.). Examples of the poly(vinylidene chloride) compounds include L502 and L513 (all trade names, manufactured by Asahi Chemical Co., Ltd.). Examples of the poly(olefin) compounds include CHEMIPEARLs S120 and SA100 (all trade names, manufactured by Mitsui Petrochemical Industries, Ltd.).

These polymer latexes may be used alone or in a blend form of two or more thereof.

The polymer latex used in the invention is particularly preferably a latex of styrene/butadiene copolymer. The weight ratio between the styrene monomer and the butadiene monomer in the styrene/butadiene copolymer is preferably from 40:60 to 95:5. The proportion of the styrene monomer unit and the butadiene monomer unit in the copolymer is preferably from 60 to 99% by mass. In the polymer latex in the invention, acrylic acid and methacrylic acid are contained preferably in an amount of 1 to 6% by mass of the total amount of styrene and butadiene, more preferably in an amount of 2 to 5% by mass thereof. The polymer latex in the invention preferably contains acrylic acid.

Preferred examples of the latex of styrene/butadiene copolymer which can be used in the invention the above-mentioned P-3 to P-8 and P-15, and LACSTARs 3307B, 7132C, and Nipol Lx416.

If desired, it is allowable to add, to the organic silver containing layer in the photosensitive material of the invention, a hydrophilic polymer such as polyvinyl alcohol, methylcellulose, hydroxypropylcellulose, or carboxymethylcellulose. The adding amount of the hydrophilic polymer is preferably 30% or less, more preferably 20% by mass or less of all binders in the organic silver salt containing layer.

The organic silver salt containing layer (that is, the image forming layer) in the invention is preferably formed using the polymer latex. About the amount of the binders in the organic silver containing layer, the weight ratio between all the binders and the organic silver salt is preferably from 1/10 to 10/1, more preferably from 1/3 to 5/1, and most preferably from 1/1 to 3/1.

Usually, such an organic silver salt containing layer is also a photosensitive layer (emulsion layer) which contains a photosensitive silver halide, which is a photosensitive silver salt. In such a case, the weight ratio of all the binders to the silver halide is preferably from 400 to 5, more preferably from 200 to 10.

In the invention, the amount of all the binders in the image forming layer is preferably from 0.2 to 30 g/m², more preferably from 1 to 15 g/m² and most preferably from 2 to 10 g/m². It is allowable to add, to the image forming layer in the invention, a crosslinking agent for crosslinking, a surfactant for improving the coating property, or some other additive.

In the invention, the solvent of the organic silver salt containing layer coating-solution in the photosensitive material is preferably an aqueous solvent containing 30% by mass or more of water. (Herein, the solvent may be a solvent or a dispersing medium for simplicity). As a component other than water, there may be used any water-miscible organic solvent such as methyl alcohol, ethyl alcohol, isopropyl alcohol, methylcellosolve, ethylcellosolve, dimethylformamide or ethyl acetate. The water content in the solvent of the coating-solution is preferably 50% or more, more preferably 70% by mass or more. Preferred examples of the solvent composition include only water, water/methyl alcohol=90/10, water/methyl alcohol=70/30, water/methyl alcohol/dimethylformamide=80/15/5, water/methyl alcohol/ethylcellosolve=85/10/5, and water/methyl alcohol/isopropyl alcohol=85/10/5 (the unit of the numerical values is “% by mass”).

Description of an Anti-Fogging Agent

Examples of an anti-fogging agent, a stabilizer and a stabilizer precursor which can be used in the invention include compounds described in JP-A No. 10-62899, paragraph 0070, EP-A1 No. 0803764, page 20, line 57 to page 21, line 7, JP-A Nos. 9-281637 and 9-329864, U.S. Pat. Nos. 6,083,681 and 6,083,681, the disclosures of which are incorporated herein by reference and European Patent No. 1048975. The anti-fogging agent which is preferably used in the invention is an organic halide compound, examples of which are disclosed in JP-A No. 11-65021, paragraphs 0111 to 0112. Particularly preferred are organic halide compounds represented by the formula (P) in JP-A No. 2000-284399, organic polyhalide compounds represented by the general formula (II) in JP-A No. 10-339934, and organic polyhalide compounds described in JP-A Nos. 2001-31644 and 2001-33911.

Description of the Polyhalide Compound

The organic polyhalide compound used in the invention will be specifically described hereinafter.

The organic polyhalide compound used in the invention has a possibility that a part thereof volatiles during thermal development. As the organic polyhalide compound has a lower melting point, the compound volatiles more easily. In order to prevent the volatilization and scattering, a polyhalide compound having a higher melting point is more desirable. If the melting point of the polyhalide compound is too high, the anti-fogging effect thereof is unfavorably lowered. In the invention, the melting point of the organic polyhalide compound is preferably from 125 to 200° C., more preferably from 130 to 175° C.

A preferred example of the polyhalide compound used in the invention is a compound represented by the following general formula (H):
Q—(Y)n—C(Z₁)X General formula (H)
wherein Q represents an alkyl, aryl or heterocyclic group, Y represents a bivalent linking group, n is 0 or 1, Z₁ and Z₂ each independently represent a halogen atom, and X represents a hydrogen atom or an electron withdrawing group.

In the general formula (H), Q is preferably an aryl or heterocyclic group.

When Q is a heterocyclic ring in the general formula (H), the ring is preferably a nitrogen-containing heterocyclic group which contains 1 or 2 nitrogen atoms, and is more preferably a 2-pyridyl or 2-quinolyl group.

When Q is an aryl group in the general formula (H), Q preferably represents a phenyl group having a substituent of an electron withdrawing group the Hammett substituent constant σp of which is a positive value. About the Hammett substituent constant, Journal of Medicinal Chemistry, 1973, Vol. 16, No. 11, 1207 to 1216 can be referred to. Examples of such an electron withdrawing group include halogen atoms (a fluorine atom (σp value: 0.06), a chlorine atom (σp value: 0.23), a bromine atom (σp value: 0.23), and a iodine atom (σp value: 0.18)), trihalomethyl groups (tribormomethyl (σp value: 0.29), trichloromethyl (σp value: 0.33), and trifluoromethyl (σp value: 0.54)), a cyano group (σp value: 0.66), a nitro group (σp value: 0.78), aliphatic, aryl or heterocyclic sulfonyl groups (for example, methanesulfonyl (σp value: 0.72)), aliphatic, aryl or heterocyclic acyl groups (for example, acetyl (σp value: 0.50), and benzoyl (σp value: 0.43)), alkynyl groups (for example, C≡CH (σp value: 0.23)), aliphatic, aryl or heterocyclic oxycarbonyl groups (for example, methoxycarbonyl (σp value: 0.45), and phenoxycarbonyl (σp value: 0.44)), a carbamoyl group (σp value: 0.36), a sulfamoyl group (σp value: 0.57), a sulfoxide group, heterocyclic groups, and a phosphoryl group. The σp value is preferably from 0.2 to 2.0, more preferably from 0.4 to 1.0. The electron withdrawing group is preferably a carbamoyl, alkoxycarbonyl, alkylsulfonyl or alkylphosphoryl group, more preferably a carbamoyl group.

X is preferably an electron withdrawing group, more preferably a halogen atom, an aliphatic, aryl or heterocyclic sulfonyl group, an aliphatic, aryl or heterocyclic acyl group, an aliphatic, aryl or heterocyclic oxycarbonyl group, a carbamoyl group, or a sulfamoyl group, and most preferably a halogen atom. Among halogen atoms, chlorine, bromine and iodine atoms are preferred. Chlorine and bromine atoms are more preferred, and a bromine atom is most preferred.

Y is preferably —C(═O)—, —SO— or —SO₂—, more preferably —C(═O)—, or —SO₂—, and most preferably —SO₂—. n is 0 or 1, and is preferably 1.

Specific examples of the compound represented by the general formula (H) in the invention will be illustrated below.

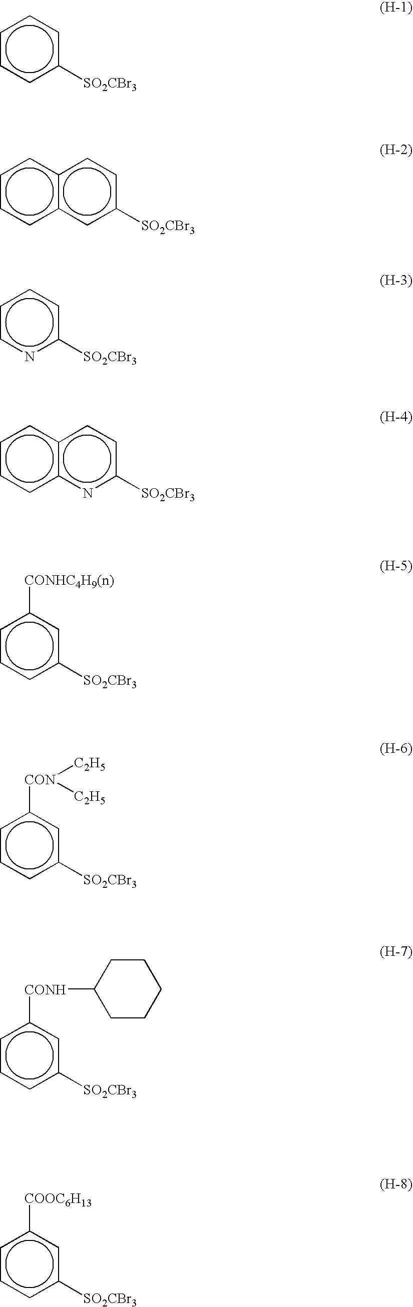

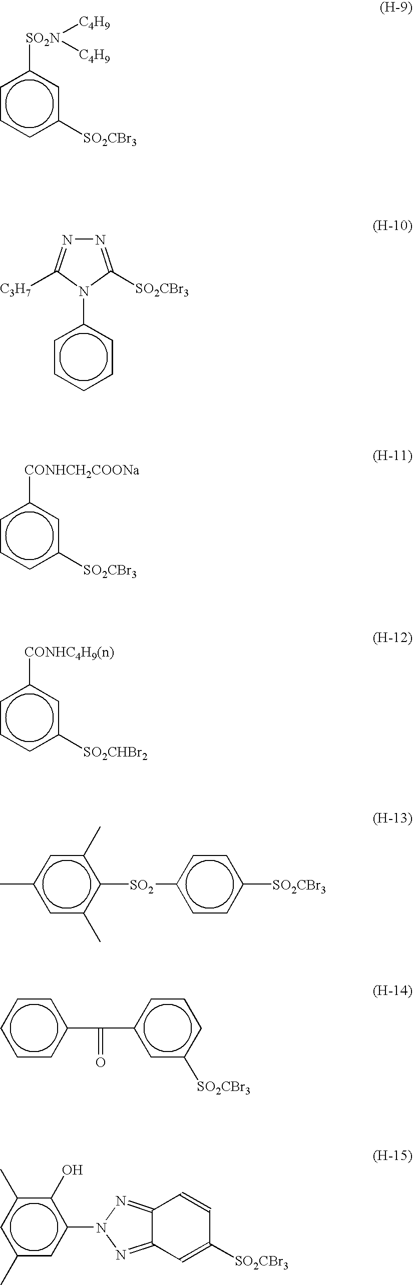

Preferred examples of the polyhalide compound in the invention include compounds described in JP-A Nos. 2001-31644, 2001-56526 and 2001-209145 besides the above-mentioned examples.

The compound represented by the general formula (H) in the invention is used preferably in an amount of 10⁻⁴ to 1 mole, more preferably in an amount of 10⁻³ to 0.5 mole, and most preferably in an amount of 1×10⁻² to 0.2 mole per mole of the non-photosensitive silver salt in the image forming layer.

In the invention, examples of the method for incorporating the anti-fogging agent into the photosensitive material may be the same methods as described as the examples of the method for incorporating the reducing agent into the photosensitive material. The organic polyhalide compound is preferably added thereto in a form of a solid fine particle dispersion.

Other examples of the anti-fogging agent include mercury (II) salts described in JP-A No. 11-65021, paragraph 0113, benzoic acid compounds described in the same publication, paragraph 0114, salicylic acid derivatives described in JP-A No. 2000-206642, formalin scavenger compounds represented by the formula (S) in JP-A No. 2000-221634, triazine compounds recited in claim 9 of JP-A No. 11-352624, compounds represented by the general formula (III) in JP-A No. 6-11791, and 4-hydroxy-6-methyl-1,3,3a,7-tetrazaindene.

The photothermographic material of the invention may contain an azolium salt for anti-fogging. Examples of the azolium salt include compounds represented by the general formula (XI) described in JP-A No. 59-193447, compounds described in JP-B No. 55-12581, and compounds represented by the general formula (II) described in JP-A No. 60-153039. The azolium salt may be added to any site of the photosensitive material, is preferably added to a layer present in the side having the photosensitive layer, and is more preferably added to the organic silver containing layer. The addition of the azolium salt may be performed in any step in the preparation of the coating-solution. In the case that the azolium salt is added to the organic silver salt containing layer, the addition may be performed in any step from the preparation of the organic silver salt to the preparation of the coating-solution, and is preferably performed after the preparation of the organic silver salt and immediately before the application of the coating-solution. The azolium salt may be added in any form, for example, in a powder form, a solution form, or a fine particle dispersion form. The azolium salt may be added in the form of a mixed solution wherein the salt is mixed with the other additives, for example, the sensitizing dye, the reducing agent and the color tone adjuster. In the invention, the adding amount of the azolium salt may be any amount, and is preferably from 1×10⁻⁶ to 2 mole (inclusive), more preferably from 1×10⁻³ to 0.5 mole (inclusive) per mole of silver.

A mercapto compound, a disulfide compound or a thione compound can be incorporated into the invention in order to suppress or promote development to control the development, or in order to improve the spectral sensitizing efficiency. These compounds are described in, for example, JP-A No. 10-62899, paragraphs 0067 to 69, JP-A No. 10-186572 (compounds represented by the general formula (I), specific examples of which are described in paragraphs 33 to 52, and EP-A1 No. 0803764, page 20, lines 36 to 56. Mercapto compounds described in JP-A Nos. 9-297367, 9-304875 and 2001-100358, and Japanese Patent Application Nos. 2001-104213 and 2001-104214 are particularly preferred.

Description of other Additives

A plasticizer and a lubricant which can be used in the photosensitive layer in the invention are described in JP-A No. 11-65021, paragraph 0117; a superhigh key image generator for forming a superhigh key image, the adding method thereof or the adding amount thereof are described in the same publication, paragraph 0118, JP-A No. 11-223898 paragraphs 0136 to 0193, JP-A No. 2000-284399 (compounds represented by the formula (H), the formulae (1) to (3), or the formula (A) or (B)) and Japanese Patent Application No. 11-91652 (compounds represented by the general formulae (III) to (V) (specific examples thereof: compounds 21 to 24)); and a superhigh key image generation promoter is described in JP-A No. 11-65021, paragraph 0102, and JP-A No. 11-223898, paragraphs 0194 to 0195.

When formic acid or a formic salt is used as a strong fogging agent, the compound is preferably incorporated into a layer present in the side having the image forming layer which contains the photosensitive silver halide in an amount of 5 mmole or less, preferably in an amount of 1 mmole or less per mole of silver.

When the superhigh key generator is used in the photothermographic material of the invention, it is preferred to use an acid obtained by hydrating diphosphorous pentaoxide, or a salt thereof together. Examples of the acid obtained by hydrating diphosphorous pentaoxide, or the salt thereof include metaphosphoric acid (salts), pyrophosphoric acid (salts), orthophosphoric acid (salts), triphosphoric acid (salts), tetraphosphoric acid (salts), and hexametaphosphoric acid (salts). Particularly preferred examples thereof include orthophosphoric acid (salts), and hexametaphosphoric acid (salts). Specific examples of the salts include sodium orthophosphate, sodium dihydrogenorthophosphate, sodium hexametaphosphate, and ammonium hexametaphosphate.

The using amount (that is, the applying amount per square meter of the photosensitive material) of the acid obtained by hydrating diphosphorous pentaoxide or the salt thereof, which may be a desired amount in accordance with the performances (such as the sensitivity and the fogging) of the photosensitive material, is preferably from 0.1 to 500 mg/m², more preferably from 0.5 to 100 mg/cm².

The reducing agent, the hydrogen-bonding compound, the development promoter, or the polyhalide compound in the invention is preferably used in the form of a solid dispersion. A preferred method for producing the solid dispersion is described in JP-A No. 2002-55405.

Description of Layer Structure

In the photothermographic material of the invention, a surface protective layer may be formed in order to prevent the adhesion of the image forming layer or other drawbacks. The surface protective layer may be a monolayered or multilayered structure. The protective layer is described in JP-A No. 11-65021, paragraphs 0119 to 120 and JP-A No. 2000-171936.

The binder used in the surface protective layer in the invention is preferably gelatin. It is also preferred to use polyvinyl alcohol (PVA) or use PVA and gelatin together. As the gelatin, inert gelatin (for example, NITTA GELATIN 750), phthalated gelatin (for example, NITTA GELATIN 801) or the like can be used. The PVA may be PVA described in JP-A No. 2000-171936, paragraphs 0009 to 0020, and is preferably PVA-105 (trade name), which is a completely-saponificated PVA, PVA205or PVA-335 (trade name), which is a partially-saponificated PVA, or MP-203 (trade name), which is a modified PVA, each of which is manufactured by Kuraray Co., Ltd. The applying amount (per square meter of the substrate) of the PVA is preferably from 0.3 to 4.0 g/m², more preferably from 0.3 to 2.0 g/m² in the monolayered surface protective layer or each of the surface protective layers.

When the photothermographic material of the invention is used for printing where dimensional change causes a problem, it is preferred to use a polymer latex in the surface protective layer or its back layer. Such a polymer latex is described in “Synthetic Emulsion” edited by Taira Okuda and Hiroshi Inagaki and published by Kobunshi Kankoukani in 1978, “Application of Synthetic Latex” edited by Takaaki Sugimura, Yasuo Kataoka, Sohichi Suzuki and Keiji Kasahara and published in Kobunshi Kankoukani in 1993, “Chemistry of Synthetic Latex” written by Sohichi Muroi and published in Kobunshi Kankoukani in 1970, and other documents. Specific examples thereof include a copolymer latex of methyl methacrylate (33.5% by mass)/ethyl acrylate (50% by mass)/methacrylic acid (16.5% by mass), a copolymer latex of methyl methacrylate (47.5% by mass)/butadiene (47.5% by mass)/itaconic acid (5% by mass), a copolymer latex of ethyl acrylate/methacrylic acid, a copolymer latex of methyl methacrylate (58.9% by mass)/2-ethylhexyl acrylate (25.4% bymass)/styrene (8.6% bymass)/2-hydroxyethyl methacrylate (5.1% by mass)/acrylic acid (2.0% by mass), and a copolymer latex of methyl methacrylate (64.0% by mass)/styrene (9.0% by mass)/butyl acrylate (20.0% by mass)/2-hydroxyethyl methacrylate (5.0% by mass)/acrylic acid (2.0% by mass). Furthermore, the following techniques may be used as the binder for the surface protective layer: combinations of polymer latexes described in Japanese Patent Application No. 11-6872, a technique described in JP-A No. 2000-267226, paragraphs 0021 to 0025, a technique in Japanese Patent Application No. 11-6872, paragraphs 0027 to 0028, and a technique described in JP-A No. 2000-19678, paragraphs 0023 to 41. The proportion of the polymer latex in the surface protective layer is preferably from 10% to 90% (inclusive), more preferably from 20 to 80% (inclusive) by weight of all the binders.

The applying amount (per square meter of the substrate) of all the binders (including the water-soluble polymer and the latex polymer) is preferably from 0.3 to 5.0 g/m², more preferably from 0.3 to 2.0 g/m² in the monolayered surface protective layer or each of the surface protective layers.

The temperature at the time of the preparation of the image forming layer coating-solution is preferably from 30 to 65° C. (inclusive), more preferably from 35 to 60° C. (inclusive), and most preferably from 35 to 55° C. (inclusive). It is also preferred that the temperature of the image forming layer coating-solution immediately after the addition of the polymer latex be kept at a temperature of 30 to 65° C. (inclusive)

The image forming layer in the invention is made of one layer or two or more sublayers on a substrate. When the image forming layer is made of a monolayer, the layer is composed of the organic silver salt, the photosensitive silver halide, the reducing agent, and the binder and, if necessary, the layer contains additional materials, for example, a color tone adjuster, a coating aid, and other aids. When the image forming layer is composed of two or more sublayers, it is essential that its first image forming layer (usually, a layer adjacent to the substrate) contains the organic silver salt and the photosensitive silver halide, and its second image forming layer or the two layers contain the other components. When the photosensitive material of the invention is a multicolor photosensitive thermal developing photographic material, the structure for developing each color may contain a combination of such two layers. Alternatively, a single layer may contain all the components as described in U.S. Pat. No. 4,708,928. In the case that the photosensitive material of the invention is a multidye multicolor photosensitive thermal developing photographic material, its respective emulsion layers are separated from each other and held by forming a functional or non-functional barrier layer between the respective photosensitive layers, as described in U.S. Pat. No. 4,460,681.

In the invention, it is possible to use various dyes or pigments (such as C.I. Pigment Blue 60, C.I. Pigment Blue 64 and C.I. Pigment Blue 15:6) in the photosensitive layer in order to improve the color tone thereof or prevent the generation of interference fringes or irradiation at the time of laser exposure. These are described in detail in WO 98/36322, JP-A Nos. 10-268465 and 11-338098, and so on.

In the photothermographic material of the invention, an anti-halation layer can be deposited by the side of the photosensitive layer farther from a light source.

The photothermographic material generally has a non-photosensitive layer as well as the photosensitive layer. The non-photosensitive layer can be classified, on the basis of the arrangement thereof, into (1) a protective layer formed over the photosensitive layer (that is, by the side of the photosensitive layer farther from the substrate), (2) an intermediate layer between the plural photosensitive layers or between the photosensitive layer and the protective layer, (3) an undercoat layer formed between the photosensitive layer and the substrate, and (4) a back layer formed by the side of the substrate opposite to the photosensitive layer. A filter layer is formed as the layer (1) or (2) in the photosensitive material. An anti-halation layer is formed as the layer (3) or (4) in the photosensitive material.

The anti-halation layer is described in JP-A No. 11-65021, paragraphs 0123 to 0124, and JP-A Nos. 11-223898, 9-230531, 10-36695, 10-104779, 11-231457, 11-352625 and 11-352626, and other documents.

The anti-halation layer contains an anti-halation dye which absorbs an exposure wavelength. In the case that the exposure wavelength is within the infrared ray range, an infrared ray absorbing dye should be used. In this case, it is preferred to use a dye which does not absorb visible rays.

When a dye which absorbs visible rays is used to prevent halation, it is preferred that the color of the dye is not substantially caused to remain after the formation of an image and that a means for achromatization by heat based on thermal development is used. It is particularly preferred that a thermally achromatizing dye and a basic precursor are added to the non-photosensitive layerand the layer is caused to function as the anti-halation layer. These techniques are described in JP-A No. 11-231457.

The adding amount of the thermally achromatizing dye is decided depending on the purpose of the dye. In general, the dye is used in such an amount that the optical density (absorbance) of the photosensitive material is more than 0.1 when the density is measured at a target wavelength. The optical density is preferably from 0.15 to 2, more preferably from 0.2 to 1. The using amount of the dye for obtaining such an optical density is generally from about 0.001 to 1 g/m².

When the dye is achromatized in this way, the optical density can be lowered to 0.1 or less after thermal development. Two or more achromatizing dyes may be used together in the photothermographic material or thermally achromatizing type recording material. In the same way, two or more basic precursors may be used together.

In the thermal achromatization using such an achromatizing dye and a basic precursor as described in JP-A No. 11-352626, it is preferred to use a material for lowering the melting point by 3° C. or more (such as diphenylsulfone, 4-chlorophenyl(phenyl)sulfone, or 2-naphthyl benzoate) together in the photosensitive material from the viewpoint of the thermally achromatizing property thereof.

A coloring agent having an absorption maximum within the range of 300 to 450 nm is added to the invention in order to improve silver color tone or image change with age. Such a coloring agent is described in JP-A Nos. 62-210458, 63-104046, 63-103235, 63-208846, 63-306436, 63-314535, 01-61745, 2001-100363, and so on.

Usually, such a coloring agent is added in an amount of 0.1 to 1 g/m². The agent is preferably added to the back layer formed by the side of the substrate opposite to the photosensitive layer.

It is also preferred to use a dye having an absorption peak within the range of 580 to 680 nm in order to adjust the base color tone. The dye for this purpose is preferably an azo methine type oil-soluble dye which has a small absorption intensity within a shorter wavelength range and is described in JP-A No. 4-359967, or a phthalocyanine type water-soluble dye described in Japanese Patent Application No. 2002-96797, and may be added to any layer. Preferably, the dye is added to the non-photosensitive layer in the emulsion face side or to the back face side.

The photothermographic material of the invention is preferably the so-called single-side photosensitive material, which has at least one photosensitive layer which contains silver halide emulsion by one side of a substrate and has a back layer by the other side.

Description of a Mat Agent

A mat agent is preferably added to the invention in order to improve the carrying performance thereof. The mat agent is described in JP-A No. 11-65021, paragraphs 0126 to 0127. When the amount of the mat agent is represented by the amount applied per square meter of the photosensitive material, the amount is preferably from 1 to 400 mg/m², more preferably from 5 to 300 mg/m².

In the invention, the form of the mat agent may be a fixed form or an indeterminate form, and is preferably a fixed form, more preferably a spherical form. The average particle size thereof is preferably from 0.5 to 10 Mm, more preferably from 1.0 to 8.0 μm, and most preferably from 2.0 to 6.0 μm. The variation coefficient of the size distribution is preferably 50% or less, more preferably 40% or less, and most preferably 30% or less. The variation coefficient is a value represented by (the standard deviation of the particle sizes)/(the average value of the particle sizes)×100. It is also preferred to use two mat agents each having a small variation coefficient, the ratio between the average particle sizes thereof being more than 3.

The mat degree of the emulsion face may be any value if stardust defects are not generated. The Beck smoothness thereof is preferably from 30 to 2000 seconds (inclusive), more preferably from 40 to 1500 seconds (inclusive). The Beck smoothness can easily be obtained according to Japanese Industrial Standard (JIS) P8119 “Smoothness Test Method of Paper and Paper Board Using a Beck Tester” and TAPPI Standard Method T479.

About the mat degree of the back layer in the invention, the Beck smoothness thereof is preferably from 10 to 1200 seconds (inclusive), more preferably from 20 to 800 seconds (inclusive), and most preferably from 40 to 500 seconds (inclusive).

In the invention, the mat agent is preferably contained in the outermost surface layer, a layer functioning as an outermost surface layer, or a layer near the outside surface, or is preferably contained in a layer functioning as a protective layer.

The back layer which can be applied to the invention is described in JP-A No. 11-65021, paragraphs 0128 to 0130.

About the photothermographic material of the invention, the film surface pH thereof is preferably 7.0 or less, more preferably 6.6 or less before thermal development. The lower limit thereof is not particularly limited, but is about 3. The pH is most preferably from 4 to 6.2. In order to adjust the film surface pH, it is preferred from the viewpoint of a decrease in the film surface pH to use an organic acid such as a phthalic acid derivative, a nonvolatile acid such as sulfuric acid, or a volatile base such as ammonia. Ammonia is particularly preferred to attain a low film surface pH since ammonia volatizes easily and can be removed in the coating-solution applying step or before thermal development.

It is also preferred to use a nonvolatile base such as sodium hydroxide, potassium hydroxide or lithium hydroxide together with ammonia. The method for measuring the film surface pH is described in JP-A No. 2000-284399, paragraph 0123.

A film hardener may be used in the respective layers, such as the photosensitive layer, the protective layer and the back layer, in the invention. Examples of the film hardener are described in “THE THEORY OF THE PHOTOGRAPHIC PROCESS FOURTH EDITION” (written by T. H. James and edited by Macmillan Publishing Co., Inc. in 1977), pages 77 to 87. The following are preferably used: chromium alum, a sodium salt of 2,4-dichloro-6-hydroxy-s-triazine, N,N-ethylenebis(vinylsulfonacetoamide), N,N-propylenebis(vinylsulfonamide), polyvalent metal ions described in the same publication, page 78, polyisocyanates described in U.S. Pat. No. 4,281,060 and JP-A No. 6-208193, epoxy compounds described in U.S. Pat. No. 4,791,042, and vinylsulfone type compounds described in JP-A No. 62-89048.

The film hardener is added in the form of a solution, and the timing of the addition of this solution to the coating-solution for forming the protective layer is from a time before 180 minutes from the application of the coating-solution to a time immediately before the application, preferably from a time before 60 minutes from the application to a time before 10 seconds therefrom. The method and conditions for the mixing in this case are not particularly limited as long as the advantageous effects of the invention are sufficiently produced. Specific examples of the mixing method include a method of mixing them in a tank wherein an average solution-remaining time obtained by calculation from the flow rate of an added solution and the solution amount supplied to a coater is set to a desired time; or a method of using a static mixer described in Chapter 8 in “Liquid Mixing Technique”, written by N. Harnby, M. F. Edwards and A. W. Nienow, translated by Koji Takahashi, and published by the Nikkan Kogyo Shimbun, Ltd. in 1989, or some other document.

A surfactant, a solvent, a substrate, and an antistatic or electrically conductive layer which can be used in the invention are described in JP-A No. 11-65021, paragraph 0132, paragraph 0133, paragraph 0134, and paragraph 0135, respectively. A method for obtaining a color image in the invention is described in the same publication, paragraph 0136, and a lubricant which can used in the invention is described in JP-A No. 11-84573, paragraphs 0061 to 0064, and Japanese Patent Application No. 11-106881, paragraphs 0049 to 0062.

The invention preferably has an electrically conductive layer which contains a metal oxide. The electrically conductive material of the conductive layer is preferably a metal oxide into which an oxygen defect or a different kind of metal atom is introduced so as to make the electric conductivity high. Preferred examples of the metal oxide include ZnO, TiO₂ and SnO₂. It is preferred to add Al or In to ZnO, add Sb, Nb, P or a halogen atom to SnO₂, and add Nb or Ta to TiO₂. SnO₂ to which Sb is added is particularly preferred. The adding amount of the different kind atom is preferably from 0.01 to 30% by mole, more preferably from 0.1 to 10% by mole. The form of the metal oxide may be spherical, needlelike, or platelike. Each particle of the metal oxide is made of a needlelike particle which preferably has a ratio of its long axis to its short axis of 2.0 or more, more preferably 3.0 to 50. The using amount of the metal oxide is preferably from 1 to 1000 mg/m², more preferably from 10 to 500 mg//m², and most preferably from 20 to 200 mg/m². The electrically conductive layer in the invention may be set into the emulsion face side or the back face side, and is preferably set between the substrate and the back layer. Specific examples of the electrically conductive layer in the invention are described in JP-A Nos. 7-295146 and 11-223901.

In the invention, a fluorine-containing surfactant is preferably used. Specific examples of the fluorine-containing surfactant include compounds described in JP-A Nos. 10-197985, 2000-19680 and 2000-214554. A fluorine-containing polymer surfactant described in JP-A No. 9-281636 is also preferred. In the photothermographic material of the invention, preferred are also fluorine-containing surfactants described in JP-A No. 2002-82411 and Japanese Patent ApplicationNos. 2001-242357 and 2001-264110. In the case that the coatings-solution is aqueous and the solution is applied to produce the photosensitive material, the fluorine-containing surfactants described in the Japanese Patent Application Nos. 2001-242357 and 2001-264110 are particularly preferred from the electrification adjusting ability thereof and the stability and slippage of the surface of the layer formed by the application. The fluorine-containing surfactant described in the Japanese Patent Application No. 2001-264110 is most preferred since the electrification adjusting ability thereof is high so that the using amount thereof can be made small.

In the invention, the fluorine-containing surfactant may be used in the emulsion face or the back face, and is preferably used in both the faces. It is particularly preferred to use a combination of the fluorine-containing surfactant with the electrically conductive layer which contains the metal oxide. In this case, sufficient performance can be obtained even if the using amount of the fluorine-containing surfactant in the face which has the electrically conductive layer is reduced or the surfactant is removed.

The using amount of the fluorine-containing surfactant is preferably from 0.1 to 100 mg/m², more preferably from 0.3 to 30 mg/m², and most preferably from 1 to 10 mg/m² in each of the emulsion face and the back face. A fluorine-containing surfactant described in Japanese Patent Application No. 2001-264110 has a particularly advantageous effect, and the amount thereof is preferably from 0.01 to 10 mg/m², more preferably from 0.1 to 5 mg/m².

The substrate may be transparent, and it is preferred to use, as the transparent substrate, a polyester substrate (in particular, a polyethylene terephthalate substrate) which is subjected to thermal treatment within the temperature range of 130 to 185° C. in order to relieve internal strain remaining in the film at the time of biaxial drawing and thermal shrinkage strain generated during thermal development. In the case that the invention is a photothermographic material for medicine, its transparent substrate may be colored with a blue dye (for example, dye-1 described in Examples of JP-A No. 8-240877) or may be colorless. It is preferred to apply, to the substrate, an undercoating technique using water-soluble polyester described in JP-A No. 11-84574, styrene/butadiene copolymer described in JP-A No. 10-186565, vinylidene chloride copolymer described in Japanese Patent Application No. 11-106881, paragraphs 0063 to 0080 and JP-A No. 2000-39684, or some other compound. About the antistatic layer or the undercoating layer, there can be used techniques described in JP-A Nos. 56-143430, 56-143431, 58-62646, 56-120519, 11-84573 (paragraphs 0040 to 0051), and 11-223898 (paragraphs 0078 to 0084), and U.S. Pat. No. 5,575,957.

The photothermographic material is preferably a mono sheet type (that is, a type making it possible to form an image on the photothermographic material without any other sheet, such as an image receiving material).

An antioxidant, a stabilizer, a plasticizer, an ultraviolet absorber, or a coating aid may be further added to the photothermographic material. The various additives are added to the photosensitive layer or the non-photosensitive layer. About these additives, WO 98/36322, EP-A1 No. 803764, and JP-A Nos. 10-186567 and 10-18568 can be referred to.

The photothermographic material of the invention may be applied by any method. Specifically, there are used various coating operations such as extrusion coating, slide coating, curtain coating, dip coating, knife coating, flow coating, and extrusion coating using a hopper described in U.S. Pat. No. 2,681,294. There is preferably used extrusion coating or slide coating described in “LIQUID FILM COATING” (written by Stephen F. Kistler, and Petert M. Schweizer and published by CHAPMAN & HALL Co. in 1997), pages 399 to 536, the disclosure of which is incorporated herein by reference. The slide coating is more preferably used. An example of a slide coater used in the slide coating is illustrated in Figure 11b.1 in the same publication. If desired, any two or more layers of the photosensitive material can be simultaneously applied by the method described in the same publication, pages 399 to 536, or the method described in U.S. Pat. No. 2,761,791 the disclosure of which is incorporated by reference herein or GB Patent No. 837,095. Particularly preferred methods for the invention are application methods described in JP-A Nos. 2001-194748, 2002-153808, 2002-153803 and 2002-182333.

The organic silver salt containing layer coating-solution in the invention is preferably the so-called thixotropic fluid. About this technique, JP-A No. 11-52509 can be referred to. The organic silver salt containing layer coating-solution in the invention preferably has a viscosity (at a shearing velocity of 0.1 S⁻¹) of 400 to 100,000 mPa·s (inclusive), and more preferably has a viscosity of 500 to 20,000 mPa·s (inclusive), and preferably has a viscosity (at a shearing velocity of 1000 S⁻¹) of 1 to 200 mPa·s (inclusive) and more preferably has a viscosity of 5 to 80 mPa·s (inclusive).

When two liquids are mixed in the case that the coating-solution in the invention is prepared, a known in-line mixer or in-plant mixer is preferably used. A preferred example of the in-line mixer is described in JP-A No. 2002-85948, and a preferred example of the in-plant mixer is described in JP-A No. 2002-90940.

In order to keep the surface state of the layer obtained from the coating-solution in the invention satisfactory, the coating-solution is preferably subjected to antifoaming treatment. A preferred example of the antifoaming treatment is described in JP-A No. 2002-66431.

When the coating solution in the invention is applied, discharging treatment is preferably conducted to prevent adhesion of dust or dirt based on electrification of the substrate. A preferred example of the discharging method in the invention is described in JP-A No. 2002-143747.

In the invention, it is important to control minutely drying wind or drying temperature for drying the non-setting emulsion coating-solution. Preferred examples of the drying method in the invention are described in detail in JP-A Nos. 2001-194749 and 2002-139814, the disclosures of which are incorporated herein by reference.

The photothermographic material of the invention is preferably subjected to heating treatment just after the application or drying thereof in order to improve the film-forming performance thereof. The temperature for the heating treatment is preferably from 60 to 100° C. as a film surface temperature, and the time for the heating treatment is from 1 to 60 seconds. More preferably, the film surface temperature is from 70 to 90° C. and the heating time is from 2 to 10 seconds. A preferred example of the heating treatment in the invention is described in JP-A No. 2002-107872.

In order to produce the photothermographic material of the invention stably and continuously, it is preferred to use production processes described in JP-A Nos. 2002-156728 and 2002-182333.

Examples of a technique which can be used in the photothermographic material of the invention also include EP-A1 Nos. 803764 and 833022, WO 98/36322, and JP-A Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2000-187298, 2000-10229, 2000-47345, 2000-206642,2000-98530, 2000-98531, 2000-112059, 2000-112060, 20000-112104, 2000-112064, and 20000-171936 the disclosures of which are incorporated herein by reference.

Description of a Packaging Material

In order to suppress variation in the photographic performance of the photosensitive material of the invention when raw stock thereof is stored, or improve the curling resistance, the winding habit or some other property thereof, it is preferred to package the photosensitive material with a packaging material having a low oxygen permeability and/or water permeability. The oxygen permeability is preferably 50 ml/atm·m²·day or less, more preferably 10 ml/atm·m²·day or less, and most preferably 1.0 ml/atm·m²·day or less at 25° C. The water permeability is preferably 10 ml/atm·m²·day or less, more preferably 5 ml/atm·m²·day or less, and most preferably 1 ml/atm·m²·day or less.

Specific examples of the packaging material having a low oxygen permeability and/or water permeability are described in, for example, JP-A Nos. 8-254793 and 2000-206653, the disclosures of which are incorporated by reference herein.

Description of Thermal Development

The photothermographic material of the invention may be developed by any method. Usually, the photosensitive material is imagewise exposed to light, and then the temperature thereof is raised to develop the photosensitive material. The developing temperature is preferably from 80 to 250° C., more preferably from 100 to 140° C., and most preferably form 110 to 130° C. The developing time is preferably from 1 to 60 seconds, more preferably from 3 to 30 seconds, still more preferably from 5 to 25 second and most preferably from 7 to 15 seconds.

The manner of the thermal development may be a drum-shaped heater manner or a plate-shaped heater manner, and is preferably a plate-shaped heater manner. The thermal development in the plate-shaped heater manner is preferably a thermal development described in JP-A No. 11-133572, using a thermal developing device for obtaining a visible image by bringing a photothermographic material on which a latent image is formed into contact with a heating means in a thermal developing section, wherein the heating means is made of a plate heater, plural pressing rollers are arranged along one face of the plate heater and oppositely to the face, and the photothermographic material is caused to pass between the pressing rollers and the plate heater so as to be thermally developed. It is preferred that the plate heater is separated to 2 to 6 pieces and the temperature of the tip portion thereof is lowered by about 1 to 10° C. The example thereof is an example in which 4 plate heaters the temperatures of which can be independently controlled are used and the temperatures are controlled to 112, 119, 121 and 120° C., respectively. Such a method is also described in JP-A No. 54-30032. Water content or organic solvent contained in the photothermographic material can be removed outside the system, and change in the shape of the substrate of the photothermographic material can be suppressed by rapid heating.

In order to make the thermal developing device small-sized and shorten the thermal developing time, it is preferred to control the heater more stably. It is also desired that exposure of a single sheet photosensitive material according to the invention is started from the top thereof and thermal development is started before the exposure of the rear end is finished. An imager for applying a preferable rapid processing to the invention is described in, for example, Japanese Patent Application Nos. 2001-088832 and 2001-091114. When this imager is used, the photosensitive material can be thermally developed with a three-piece plate-shaped heater wherein the temperatures of the pieces are controlled to 107, 121, and 121° C., respectively, in 14 seconds. The time for outputting a first developed material can be shortened to about 60 seconds. For such rapid development, it is preferred to use the photothermographic material of the invention which has a high sensitivity and is less affected by environment temperature in the imager.

The thermal developing device for treating the photothermographic material of the invention may have a filter for collecting volatilized material. The raw material of the filter may be commercially available activated carbon, zeolite, silica gel, fibrous glass, ceramic fiber, polyester fiber or thelike. Among materials, activated carbon is most preferable. The activated carbon is preferably of a coconut shell type or coal type. The surface area thereof is preferably from 100 to 3000 m²/g, more preferably 500 to 1500 m²/g. The material which makes the frame or cartridge of the filter may be any one, and is preferably a metal, a plastic, a polymer material or the like.

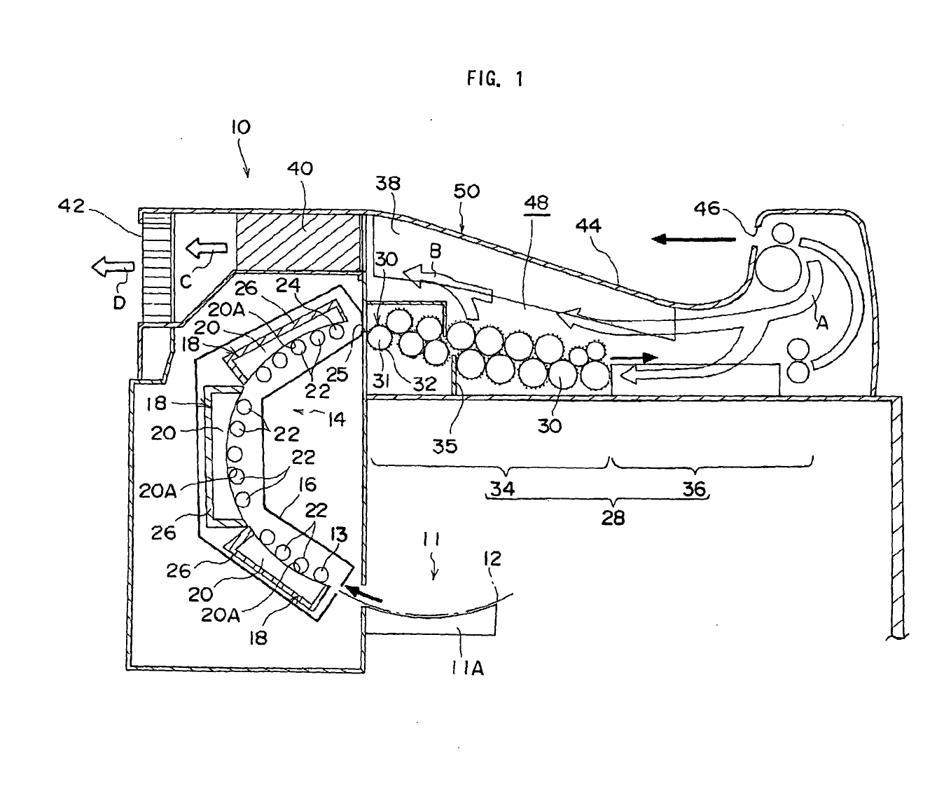

One example of the thermal developing device in the invention is illustrated in FIG. 1. However, the device is not limited to this example.

An exposed photothermographic material 12 is transferred to a thermal developing section 14 along an arrow direction. While the photothermographic material 12 is carried between heating panels 20 and pressing rollers 22 by the rotation of the rollers 22, the material 12 is heated from the rear face (that is, the face opposite to the exposed face). The heating panels 20 and the pressing rollers 22 are composed of three pairs. The thermal developing time of the material 12 is defined as the total time when the material 12 passes through the three pairs. Volatilized gas generated during the heating is carried along the flow (shown by a white solid arrow) of absorbed gas, based on a ventilating fan 42, and is collected by a filter 40. The photothermographic material 12 is discharged from an outlet 25, and the material 12 is cooled while being caused to pass between cooling rollers 30. The material 12 is discharged from a discharging port 46, and is collected in a collecting section 44.

The photosensitive material of the invention may be exposed to light by any method. The light source for the exposure is preferably a laser ray. The laser ray is preferably a gas laser (Ar⁺ or He—Ne), a YAG laser, a dye layer, a semiconductor laser, or the like. A semiconductor laser, and a second harmonic generator or the like may be used. The laser is more preferably a gas or semiconductor laser for emitting red wavelengths to infrared ray wavelengths.

An example of a laser imager for medicine having an exposure section and a thermal developing section is a Fuji Medical Dry Laser Imager FM-DP L (trade name, manufactured by FujiFilm Medical Co., Ltd.). The FM-DP L is described in Fuji Medical Review No. 8, pages 39 to 55, and techniques described therein can be applied to a laser imager for the photothermographic material of the invention. The invention can also be applied to a photothermographic material for a laser imager in an “AD network” suggested as a network system fitted to the DICOM standard by FujiFilm Medical Co., Ltd.

The photothermographic material of the invention is preferably used as a photothermographic material for medical diagnosis, a photothermographic material for industrial photography, a photothermographic material for printing, or a photothermographic material for COM, on each of which a monochromic image based on silver is formed.

### EXAMPLES

The present invention will be specifically explained by way of Examples below, but the invention is not limited by them.

### Example 1

1) Preparation of PET Support

Using terephthalic acid and ethylene glycol, PET having an intrinsic viscosity IV=0.66 (measured in phenol/tetrachloroethane=6/4 (weight ratio) at 25° C.) was obtained. This was pelletized, dried at 130° C. for 4 hours, melted at 300° C., extruded through a T die, and cooled to make an unstretched film having such a thickness that a thickness after thermal setting became 175 μm.

This was stretched at 3.3-fold in a machine direction using rolls having different circumferential rates and, then, stretched at 4.5-fold in a transverse direction with a tenter. Temperatures thereupon were 110° C. and 130° C., respectively. Thereafter, this was thermally set at 240° C. for 20 seconds, and relaxed by 4% in a transverse direction at the same temperature. Thereafter, a chuck part of the tenter was subjected to slitting, both ends were subjected to Narr processing, and wound at 4 kg/cm² to obtain a roll having a thickness of 175 μm.

2) Surface Corona Treatment

Using a corona treating machine (trade name: Solid State corona treating machine 6KVA model, manufactured by Pillar), both surfaces of a support were treated at room temperature at 20 m/min. From readings of a current and a voltage upon this, it was found that a support is treated at 0.375 kV·A·min/m². Upon this, a treating frequency was 9.6 kHz, and a gap clearance between an electrode and a dielectric roll was 1.6 mm.

3) Preparation of Undercoated Support

| Formulation 1 (for photosensitive layer side undercoating) | | |
|---|---|---|
| Polyester resin (trade name: Pesresin A-520 (30% by weight | 59 | g |
| solution), manufactured by Takamatsu Oil & Fat Co., Ltd.) | | |
| Polyethylene glycol monononyl phenyl ether | 5.4 | g |
| (Average ethylene oxide number = 8.5) 10% by weight solu- | | |
| tion | | |
| Polymer fine particle (trade name: MP-1000, manufactured by | 0.91 | g |
| Soken Chemical & Engineering Co., Ltd.) | | |
| Distilled water | 935 | ml |
| Formulation 2 (for back surface first layer) | | |
| Styrene-butadiene copolymer latex (40% by weight of solid | 158 | g |
| content, styrene/butadiene weight ratio = 68/32) | | |
| 2,4-Dichloro-6-hydroxy-s-triazine sodium salt (8% by weight | 20 | g |
| aqueous solution) | | |
| 1% by weight aqueous solution of sodium laurylbenzene- | 10 | ml |
| sulfonate | | |
| Distilled water | 854 | ml |
| Formulation 3 (for back surface side second layer) | | |
| SnO₂/SbO (9/1 mass ratio, average particle diameter: | 84 | g |
| 0.038 μm, 17% by weight dispersion) | | |
| Gelatin (10% by weight aqueous solution) | 89.2 | g |
| Cellulose derivative (trade name: Methorose TC-5, manufac- | 8.6 | g |
| tured by Shin-Etsu Chemical Co., Ltd.) (2% by weight | | |
| aqueous solution) | | |
| Polymer fine particle (trade name: MP-1000, manufactured by | 0.01 | g |
| Soken Chemical & Engineering Co., Ltd., average particle | | |
| diameter 0.4 μm) | | |
| 1 weight % aqueous solution of sodium dodecylbenzene- | 10 | ml |
| sulfonate | | |
| NaOH (1% by weight) | 6 | ml |
| Antifungal agent (trade name: Proxel, manufactured by ICI) | 1 | ml |
| Distilled water | 805 | ml |

(2) Coating of Undercoating Layer

Each of both sides of the aforementioned biaxial stretched polyethylene terephthalate support having a thickness of 175 μm was subjected to the aforementioned corona discharge treatment, (1) the aforementioned undercoating coating solution formation was coated on one side (photosensitive layer side) at a wet coating amount of 6.6 ml/m² (per one side) with a wire bar, and dried at 180° C. for 5 minutes and, then, (2) the aforementioned undercoating coating solution formulation was coated on a back side at a wet coating amount of 5.7 ml/m² with a wire bar, and dried at 180° C. for 5 minutes, further, (3) the aforementioned undercoating coating solution formulation was coated on the back side at a wet coating amount of 7.7 ml/m² with a wire bar, and dried at 180° C. for 6 minutes to prepare an undercoated support.

Back Layer

1) Preparation of Back Coating Solution

Preparation of (a) Solid Fine Particle Dispersion of Base Precursor

2.5 kg of the base precursor compound-1, 300 g of a surfactant (trade name: Demol N, manufactured by Kao Corporation), 800 g of diphenylsulfone, 1.0 g of benzoisothiazolinone sodium salt and distilled water were mixed to a total amount of 8.0 kg, and the mixed solution was beads-dispersed using a transverse-type sand mill (trade name: UVM-2, manufactured by AIMEX). As a dispersing method, the mixed solution was fed to UVM-2 charged with zirconia beads having an average diameter of 0.5 mm with a diaphragm pomp, and dispersed in the state at an internal pressure of 50 hPa or higher until a desired average particle diameter was obtained.

The dispersion was dispersed until a ratio of absorbance at 450 nm and absorbance at 650 nm (D450/D650) in spectral absorption of the dispersion as determined by spectral absorption measurement became 3.0. The resulting dispersion was diluted with distilled water so that the concentration of a base precursor became 25% by weight, and filtered with a filter (average pore diameter: using a 3 μm polypropylene filter) in order to trash, which was put into practice.

Preparation of Dye Solid Fine Particle Dispersion

6.0 kg of the cyanine dye compound-1, 3.0 kg of sodium p-dodecylbenzenesulfonate, 0.6 kg of a surfactant (trade name: Denol SNB, manufactured by Kao Corporation) and 0.15 kg of a defoaming agent (trade name: Surfinol 104E, manufactured by Nisshin Chemicals Co., Ltd.) were mixed with distilled water to a total solution amount of 60 kg. The mixed solution was dispersed with 0.5 mm zirconia beads using a transverse-type sand mill (trade name: UVM-2, manufactured by AIMEX).

The dispersion was dispersed until a ratio of absorbance at 650 nm and absorbance at 750 nm (D650/D750) in spectral absorption of the dispersion as determined by spectral absorption measurement became 5.0 or larger. The resulting dispersion was diluted with distilled water so that the concentration of a cyanine dye became 6% by weight, and filtered with a filter (average pore diameter, 1 μm) to remove trash, which was put into practice.

Preparation of Halation Preventing Layer Coating Solution

A temperature of a container was retained at 40° C., and 40 g of gelatin, 20 g of monodisperse polymethyl methacrylate fine particle (average particle size: 8 μm, particle diameter standard deviation: 0.4), 0.1 g of benzoisothiazolinone and 490 ml of water were added to dissolve gelatin. Further, 2.3 ml of a 1 mol/l aqueous sodium hydroxide solution, 40 g of the aforementioned dye solid fine particle dispersion, 90 g of (a) the aforementioned solid fine particle dispersion of a base precursor, 12 ml of a 3% aqueous sodium polystyrene sulfonate solution and 180 g of a 10% SBR latex solution were mixed. Immediately before coating, 80 ml of a 4% aqueous N,N-ethylenebis(vinylsulfoneacetamide) solution was mixed therein to obtain a halation preventing layer coating solution. Preparation of back surface protecting layer coating solution

A temperature of a container was retained at 40° C., and 40 g of gelatin, 35 mg of benzoisothiazolinone and 840 ml of water were added to dissolve gelatin. Further, 5.8 ml of a 1 mol/l aqueous sodium hydroxide solution, 1.5 g of liquid paraffin emulsion as liquid paraffin, 10 ml of a 5% aqueous di(2-ethylhexyl) sulfosuccinate sodium salt solution, 20 ml of a 3% aqueous sodium polystyrene sulfonate solution, 2.4 ml of a 2% fluorine type surfactant (F-1) solution, 2.4 ml of a 2% fluorine type surfactant (F-2) solution, and 32 g of a 19% by weight methyl methacrylate/sutyrene/butyl acrylate/hydroxyethyl methacrylate/acrylic acid copolymer (copolymerization ratio 57/8/28/5/2) latex solution were mixed. Immediately before coating, 25 ml of 4% aqueous N,N-ethylenebis(vinylsulfoneacetamide) solution was mixed therein to obtain a back surface protecting layer coating solution.

2) Coating of Back Layer

The back surface side of the aforementioned undercoated support was coated with the halation preventing layer coating solution solution at a coating amount of 0.52 g/m² of gelatin, and at the same time, the back surface protecting layer coating solution was applied thereon at a coating amount of 0.52 g/m² of gelatin, and dried to prepare a back layer.

Preparation of Image Forming Layer, Intermediate Layer, and Surface Protecting Layer

1. Preparation of Coating Materials

1) Preparation of Silver Halide Emulsion

Preparation of Silver Halide Emulsion 1

3.1 ml of a 1% by weight potassium bromide solution was added to 1421 ml of distilled water, and 3.5 ml of sulfuric acid having the concentration of 0.5 mol/l and 31.7 g of phthalated gelatin were added to obtain a solution, a temperature of which was retained at 30° C. while stirring in a reaction pot, and a solution A obtained by diluting to 22.22 g of silver nitrate to 95.4 ml by adding distilled water and a solution B obtained by diluting 15.3 g of potassium bromide and 0.8 g of potassium iodide to a volume of 97.4 ml with distilled water were added at a total amount at a constant flow rate over 45 seconds. Thereafter, 10 ml of a 3.5% by weight aqueous hydrogen peroxide solution was added, and 10.8 ml of 10% by weight aqueous benzoimidazole solution was further added. Further, a solution C obtained by diluting 51.86 g of silver nitrate to 317.5 ml by adding distilled water and a solution D obtained by diluting 44.2 g of potassium bromide and 2,2 g of potassium iodide to a volume of 400 ml with distilled water were added at a total amount at a constant flow rate over 20 minutes in the case of the solution C, or by a controlled double jet method while maintaining a pAg at 8.1 in the case of the solution D.

A total amount of a potassium salt of hexachloro iridate (III) was added to 1×10⁻⁴ mol per 1 mol of silver 10 minutes after initiation of addition of the solution C and the solution D. In addition, a total amount of an aqueous potassium hexacyanoferrate (II) solution was added at 3×10⁻⁴ mol per 1 mol of silver 5 seconds after completion of addition of the solution C. pH thereof was adjusted to 3.8 using sulfuric acid having the concentration of 0.5 mol/L, stirring was stopped, and a precipitation/desalting/water washing step was performed. pH thereof was adjusted to 5.9 using sodium hydroxide having the concentration of 1 mol/L to prepare a silver halide dispersion having a pAg of 8.0.

A temperature of the aforementioned silver halide dispersion was maintained at 38° C. while stirring, 5 ml of a 0.34% by weight solution of 1,2-benzoisothiazolin-3-one in methanol and, 40 minutes after, a temperature was elevated to 47° C. After 20 minutes from temperature elevation, a solution of sodium benzenethiosulfonate in methanol was added at 7.6×10⁻⁵ mol per 1 mol of silver and, further, after 5 minutes, a solution of a tellurium sensitizing agent C in methanol was added at 2.9×10⁻⁴ mol per 1 mol of silver, followed by aging for 91 minutes. Thereafter, a solution of a spectral sensitizing pigment A and a sensitizing pigment B at a molar ratio of 3:1 in methanol was added at a total of sensitizing pigments A and B of 1.2×10⁻³ mol per 1 mol of silver and, after 1 minute, 1.3 ml of a 0.8% by weight solution of N,N′-dihydroxy-N″-diethylmelamine in methanol was added and, further 4 minutes after, a solution of 5-methyl-2-mercaptobenzoimidazole in methanol at 4.8×10⁻³ mol per 1 mol of silver, a solution of 1-phenyl-2-heptyl-5-mercapto-1,3,4-triazole in methanol at 5.4×10⁻³ mol per 1 mol of silver and an aqueous solution of 1-(3-methylureido)-5-mercaptotetrazole sodium salt at 8.5×10⁻³ mol per 1 mol of silver were added to prepare a silver halide emulsion 1.

A particle in the prepared silver halide emulsion was a silver bromide iodide particle containing 3.5% by mol iodine uniformly and having an average sphere-equivalent diameter of 0.042 μm and a variation coefficient of a sphere-equivalent diameter of 20%. A particle size and the like were obtained from an average of 1000 particles using an electron microscope. A [100] plane ratio of this particle was estimated to be 80% using a Kubelka-Munk method.

Preparation of Silver Halide Emulsion 2s

According to the same manner as that of preparation of the silver halide emulsion 1 except that a solution temperature at particle formation was changed from 30° C. to 47° C., 15.9 g of potassium bromide was diluted with distilled water to a volume of 97.4 ml in the solution B, 45.8 g of potassium bromide was diluted with distilled water to a volume of 400 ml in the solution D, a time of adding the solution C was 30 minutes, and potassium hexacyanoferrate (II) was removed, a silver halide emulsion 2 was prepared. Preparation/desalting/water washing/dispersion were performed as in the silver halide emulsion 1. Further, according to the same manner as that of the emulsion 1 except that an amount of a tellurium sensitizing agent C to be added was changed to 1.1×10⁻⁴ mol per 1 mol of silver, an amount of a solution of a Spectral sensitizing pigment A and a Spectral sensitizing pigment B at a molar ratio of 3:1 in methanol to be added was changed to a total of the sensitizing pigment A and the sensitizing pigment B per 1 mol of silver of 7.0×10⁻⁴ mol, 1-phenyl2-heptyl-5-mercapto-1,3,4-triazole was changed to 3.3×10⁻³ mol per 1 mol of silver, and 1-(3-methylureido)-5-mercaptotetrazole sodium salt was changed to 4.7×10⁻³ mol per 1 mol of silver, chemical sensitization, and addition of 5-methyl-2-mercaptobenzoimidazole and 1-phenyl-2-heptyl-5-mercapto1,3,4-triazole were performed to obtain a silver halide emulsion 2. An emulsion particle of the silver halide emulsion 2 was a pure silver bromide cubic particle having an average sphere-equivalent diameter of 0.080 μm and a variation coefficient of a sphere-equivalent diameter of 20%.

Preparation of Silver Halide Emulsion 3

According to the same manner as that of preparation of the silver halide emulsion 1 except that a solution temperature at particle formation was changed from 30° C. to 27° C., a silver halide emulsion 3 was prepared. In addition, precipitation/desalting/water washing/dispersion were performed as in the silver halide emulsion 1. According to the same manner as that of the emulsion 1, except that an amount of a Spectral sensitizing pigment A and a Spectral sensitizing pigment B at a molar ratio of 1:1 as a solid dispersion (aqueous gelatin solution) to be added was changed to a total of a sensitizing pigment A and a sensitizing pigment B of 6×10⁻³ mol per 1 mol of silver, an amount of a tellurium sensitizing agent C to be added was changed to 5.2×10⁻⁴ mol per 1 mol of silver and, 3 minutes after addition of the tellurium sensitizing agent, aurate bromide was added at 5×10⁻⁴ mol per 1 mol of silver and potassium thiocyanate was added at 2×10⁻³ mol per 1 mol of silver, a silver halide emulsion 3 was obtained. An emulsion particle of the silver halide emulsion 3 was a silver bromide iodide particle uniformly containing 3.5% by mol of iodine and having an average sphere-equivalent diameter of 0.034 μm and a variation coefficient of a sphere-equivalent diameter of 20%.

Preparation of Mixed Emulsion A for Coating Solution

70% by weight of the silver halide emulsion 1, 15% by weight of the silver halide emulsion 2 and 15% by weight of the silver halide emulsion 3 were dissolved, and a 1% by weight aqueous benzothiazolium iodide solution was added at 7×10⁻³ mol per 1 mol of silver. Further, water was added so that the content of silver halide per 1 kg of a mixed emulsion for coating solution became 38.2 g as silver, and a sodium salt of 1(3-methylurado)-5-mercaptotetrazole was added at 0.34 g per 1 kg of a mixed emulsion for coating solution.

2) Preparation of Fatty Acid Silver Dispersion

Preparation of Recrystallized Behenic Acid

100 kg of behenic acid (trade name: Edelor C22-85R, manufactured by Henkel) was mixed with 1200 kg of isopropyl alcohol, dissolved at 50° C., filtered with a 10 μm filter, and recrystallization was performed by cooling to 30° C. A cooling speed upon recrystallization was controlled at 3° C./hour. The resulting crystal was filtered by centrifugation, and washed with 100 kg of isopropyl alcohol, and dried. The resulting crystal was esterified, subjected to GC-FID measurement, and it was found that the content of behenic acid is 96% and, besides, 2% of lignoceric acid, 2% of arachidic acid and 0.001% of erucic acid are contained.

Preparation of Fatty Acid Silver Dispersion B

88 kg of recrystallized behenic acid, 422 L of distilled water, 49.2 L of an aqueous NaOH solution having the concentration of 5 mol/L and 120 L of t-butyl alcohol were mixed, and stirred at 75° C. for 1 hour to react, to obtain sodium behenate solution B. Separately, 260.2 L of an aqueous solution of 40.4 kg of silver nitrate (pH 4.0) was prepared, and a temperature of the solution was retained at 10° C. A temperature of a reaction vessel in which 635 L of distilled water and 30 L of t-butyl alcohol were placed was retained at 30° C., and a total amount of the sodium behenate solution B and a total amount of the aqueous silver nitrate solution were added at a constant flow rate over 93 minutes and 15 seconds and 90 minutes, respectively, while stirring well. Upon this, for 11 minutes after initiation of addition of the aqueous silver nitrate solution, only the aqueous silver nitrate solution was added and, thereafter, addition of the sodium behenate solution B was initiated and, for 14 minutes and 15 seconds after completion of addition of the aqueous nitrate solution, only the sodium behenate solution B was added. Upon this, a temperature in the reaction vessel was 30° C., and an external temperature was controlled so that a solution temperature became constant. In addition, a temperature of a piping of a system for adding the sodium behenate solution B was retained by circulating warm water outside a double tube, and a solution temperature of an exit at a tip of an addition nozzle was regulated at 75° C. In addition, a temperature of a piping of a system for adding the aqueous silver nitrate solution was retained by circulating cold water outside a double tube. A position of adding the sodium behenate solution B and a position of adding the aqueous silver nitrate solution were disposed symmetrically relative to a stirring axis as a center, and heights are regulated so as not to contact with a reaction solution.

After completion of addition of the sodium behenate solution B, the solution was allowed at that temperature for 20 minutes while stirring, and a temperature was elevated to 35° C. for 30 minutes, followed by aging for 210 minutes. Immediately after completion of aging, the solid was filtered off by centrifugation filtration, and the solid was washed with water until the conductivity of filtering water became 30 μS/cm. Thus, fatty acid silver salt was obtained. The resulting solid was stored as a wet cake without drying.

The form of the resulting silver behenate particle was evaluated with electron microscope imaging, and a crystal was found to have, as an average, a=0.21 μm, b=0.4 μm, c=0.4 μm, average aspect ratio of 2.1, and a variation coefficient of a sphere-equivalent diameter of 11% (a,b and c were defined in the text).

b 19.3 kg of polyvinyl alcohol (trade name: PVA-217, manufactured by Kurarey Co., Ltd.) and water were added to the wet cake corresponding to 260 kg of the dry solid, to a total amount of 1000 kg, the material was slurried with a dissolver wing, and further pre-dispersed with a pipeline mixer (trade name:PM-10 type, manufactured by MIZUHO Industrial Co., Ltd.).

Then, the pre-dispersed stock solution was treated three times with a dispersing machine (trade name: Microfluidizer M-610, manufacturedbyMicrofluidexInternationalCorporation, using Z-type interaction chamber) by regulating a pressure at 1150 kg/cm², to obtain the silver behenate dispersion. The cooling procedures were as follows: each of hose heat exchangers was mounted before and after the interaction chamber, and a dispersion temperature was set at 18° C. by regulating a temperature of a cooling medium.

3) Preparation of Reducing Dispersion

Preparation of Reducing Agent-1 Dispersion

10 kg of water was added to 10 kg of the reducing agent-1 (6,6′-di-t-butyl-4,4′-dimethyl-2,2′-butylidenediphenol) and 16 kg of a 10% by weight aqueous solution of denatured polyvinyl alcohol (trade name: Povar MP203, manufactured by Kuraray Co. Ltd.), and mixed well to obtain a slurry. This slurry was fed with a diaphragm pomp, dispersed for 3 hours and 30 minutes with a transverse type sand mill (trade name: UVM-2, manufactured by AIMEX) charged with zirconia beads having an average diameter of 0.5 mm, and 0.2 g of a sodium salt of benzoisothiazolinone and water were added to adjust the concentration of a reducing agent to 25% by weight. This dispersion was heated at 40° C. for 1 hour, and subsequently heat-treated at 80° C. for 1 hour to obtain a reducing agent-2 dispersion. A reducing agent particle contained in the thus obtained reducing agent dispersion had a median diameter of 0.50 μm and a maximum particle diameter of 1.6 μm or smaller. The resulting reducing agent dispersion was filtered with a polypropylene filter having a pore diameter of 3.0 μm to remove foreign matter such as a trash and the like, followed by storing.

4) Preparation of Hydrogen Bond-Forming Compound-1 Dispersion

10 kg of water was added to 10 kg of the hydrogen bond-forming compound-1 (tri(4-t-butylphenyl)phosphine oxide) and 16 kg of a 10% by weight aqueous solution of denatured polyvinyl alcohol (trade name: Povar MP 203, manufactured by Kuraray Co., Ltd.), and mixed well to obtain a slurry. This slurry was fed with a diaphragm pump, dispersed for 4 hours with a transverse-type sand mill (trade name: UVM-2, manufactured by AIMEX) charged with zirconia beads having an average diameter of 0.5 mm, and 0.2 g of a sodium salt of benzoisothiazolinone and water were added to adjust the concentration of the hydrogen bond-forming compound to 25% by weight. This dispersion was heated at 40° C. for 1 hour, and subsequently warmed at 80° C. for 1 hour to obtain the hydrogen bond-forming compound-1 dispersion. A hydrogen bond-forming compound particle contained in the thus obtained hydrogen bond-forming compound dispersion had a median diameter of 0.45 μm and a maximum particle diameter of 1.3 μm. The resulting hydrogen bond-forming compound dispersion was filtered with a polypropylene filter having a pore diameter of 3.0 μm, to remove foreign matters such as a trash, followed by storing.

5) Preparation of Development Promoter-1 Dispersion

10 kg of water was added to 10 kg of the development promoter-1 and 20 kg of 10% by weight aqueous solution of denatured polyvinyl alcohol (trade name: Povar MP 203, manufactured by Kuraray Co., Ltd.), and mixed well to obtain a slurry. This slurry was fed with a diaphragm pump, dispersed for 3 hours and 30 minutes with a transverse-type sand mill (trade name: UVM-2, manufactured by AIMEX) charged with zirconia beads having an average diameter of 0.5 mm, and 0.2 g of a sodium salt of benzoisothiazolinone and water were added so that the concentration of development promoter became 20% by weight, to obtain a development promoter 1 dispersion. A development promoter particle contained in the thus obtained development promoter dispersion had a median diameter of 0.48 μm and a maximum particle diameter of 1.4 μm. The resulting development promoter dispersion was filtered with a polypropylene filter having a pore diameter of 3.0 μm, to remove foreign matters such as a trash and the like, followed by storing.

Preparation of Solid Dispersions of Development Promoter-2 and Color Tone Adjuster-1

Regarding Solid Dispersions of the Development promoter-2 and the color tone adjuster-1, according to the same manner as that of the development promoter-1, the materials were dispersed as in the developing-1, to obtain 20% by weight dispersion and 15% by weight dispersions, respectively.

6) Preparation of Polyhalogen Compound Dispersion

Preparation of organic polyhalogen compound-1 dispersion

10 kg of an organic polyhalogen compound-1 (tribromomethanesulfonylbenzene), 10 kg of a 20% by weight aqueous solution of denatured polyvinyl alcohol (trade name: Povar MP 203, manufactured by Kurarey Co., Ltd .), 0.4 kg of a 20% by weight aqueous solution of sodium triisopropylnaphthalenesulfonate and 14 kg of water were added, and mixed well to obtain a slurry. This slurry was fed with a diaphragm pump, dispersed for 5 hours with a transverse-type sand mill (trade name: UVM-2, manufactured by AIMEX) charged with zirconia beads having an average diameter of 0.5 mm, and 0.2 g of a sodium salt of benzoisothiazolinone and water were added so that the concentration of the organic polyhalogen compound became 26% by weight, to obtain an organic polyhalogen compound-1 dispersion. An polyhalogen compound particle contained in the thus obtained polyhalogen compound had a median diameter of 0.41 μm and a maximum particle diameter of 2.0 μm. The resulting organic polyhalogen compound dispersion was filtered with a polypropylene filter having a pore diameter of 10.0 μm, to remove foreign matters such as a trash and the like, followed by storing.

Preparation of Organic Polyhalogen Compound-2 Dispersion

10 kg of an organic polyhalogen compound-2 (N-butyl3-tribromomethanesulfonylbenzamide), 20 kg of a 10% by weight aqueous solution of denatured polyvinyl alcohol (trade name: Povar MP 203, manufactured by Kurarey Co., Ltd.), and 0.4 kg of a 20% by weight aqueous solution of sodium triisopropylnaphthalenesulfonate were added, and mixed well to obtain a slurry. This slurry was fed with a diaphragm pump, dispersed for 5 hours with a transverse-type sand mill (trade name: UVM-2, manufactured by AIMEX) charged with zirconia beads having an average diameter of 0.5 mm, and 0.2 g of a sodium salt of benzoisothiazolinon e and water were added to adjust the concentration of the organic polyhalogen compound to 30% by weight. This dispersion was warmed at 40° C. for 5 hours to obtain an organic polyhalogen compound-2 dispersion. An organic polyhalogen compound particle contained in the thus obtained polyhalogen compound dispersion had a median diameter of 0.40 μm and a maximum particle diameter of 1.3 μm or smaller. The resulting organic polyhalogen compound dispersion was filtered with a polypropylene filter having a pore diameter of 3.0 μm, to remove foreign matters such as a trash and the like, followed by storing.

Preparation of Phthalazine Derivative Solution

80 g of denatured polyvinyl alcohol (trade name: MP 203, manufactured by Kurarey Co., Ltd.) was dissolved in 1.75 kg of water, and 32 g of a 20% by weight aqueous solution of sodium triisopropylnaphthalenesulfonate and 100 g of a phthalazine derivative (kind and amount thereof are shown in Table 1) were added to prepare a 5% by weight solution of the phthalazine derivative.

Preparation of Mercapto Compound

Preparation of Aqueous Mercapto Compound-2 Solution

20 g of a mercapto compound-2 (sodium salt of 1-(3methylureido)-5-mercaptotetrazole) was dissolved in 980 g of water to obtain a 2.0% by weight aqueous solution.

9) Preparation of Pigment-1 Dispersion

64 g of C. I. Pigment Blue 60 and 6.4 g of a surfactant (trade name: Demol N, manufactured by Kao Corporation) were added to 250 g of water, and mixed well to obtain a slurry. 800 g of zirconia beads having an average diameter of 0.5 mm were prepared, placed into a vessel together with the slurry, dispersed for 25 hours with a dispersing machine (trade name: ¼ G sand grinder mill, manufactured by AIMEX), and water was added to adjust the concentration of the pigment to 5% by weight to obtain a pigment dispersion. A pigment particle contained in the thus obtained pigment dispersion had an average particle diameter of 0.21 μm.

10) Preparation of SBR Latex

SBR Latex was Prepared as Follows:

287 g of distilled water, 7.73 g of a surfactant (trade name: Pionin A-43-S, manufactured by Takemoto Oil & Fat Co., Ltd.: solid 48.5%), 14.06 ml of 1 mol/liter NaOH, 0.15 g of a tetrasodium salt of ethylenediaminetetraacetic acid, 255 g of styrene, 11.25 g of acrylic acid and 3.0 g of tert-dodecylMercapto were placed into a polymerization kettle of a gas monomer reaction apparatus (trade name: TAS-2J Type, manufactured by TAIATSU TECHNO CORPORATION), and the reaction vessel was sealed, followed by stirring at a stirring rate of 200 rpm. The vessel was degassed with a vacuum pump, nitrogen gas replacement was repeated several times, 108.75 g of 1,3-butadiene was pressed into the vessel, and an internal temperature was raised to 60° C. To this was added a solution in which 1.875 g of ammonium persulfate was dissolved in 50 ml of water, and stirred as it was for 5 hours. A temperature was further raised to 90° C., the material was stirred for 3 hours and, after completion of the reaction, an internal temperature was lowered to room temperature, treatment was performed to Na+ion:NH₄+ion=1:5.3 (molar ratio) using 1 mol/liter of NaOH and NH₄OH, and a pH was adjusted to 8.4. Thereafter, filtration was performed with a polypropylene filter having a pore diameter of 1.0 μm to remove foreign matter such as a trash, and 774.7 g of SDR latex was obtained. A halogen ion was measured by ion chromatography, and the chloride ion concentration was found to be 3 ppm. The concentration of a chelating agent was measured by high speed liquid chromatography was measured, and it was found to be 145 ppm.

The aforementioned latex had an average particle diameter of 90 nm, Tg=17° C., the solid concentration of 44% by weight, the equilibrium moisture content at 25° C. and 60% RH of 0.6% by weight, and the ion conductivity of 4.80 mS/cm (the ion conductivity of the latex stock solution (44% by weight) was measured at 25° C. using a conductivity meter (trade name: CM-30S, manufactured by DKK-TOA Corporation)).

Preparation of Coating Solutions

Preparation of Image Forming Layer Coating Solutions

1000 g of the above-obtained fatty acid silver dispersion B, 135 ml of water, 36 g of the pigment-1 dispersion, 25 g of the organic polyhalogen compound-1 dispersion, 39 g of the organic polyhalogen compound-2 dispersion, the phthalazine derivative (kind and amount thereof are shown in Table 1), 1060 g of the SBR latex (Tg: 17° C.) solution, 153 g of the reducing agent-2 dispersion, 55 g of hydrogen bond-forming compound-1 dispersion, 4.8 g of the development promoter-1 dispersion, 5.2 g of the development promoter-2 dispersion, 2.1 g of the color tone adjuster-1 dispersion, and 8 ml of the aqueous mercapto compound-2 solution were successively added and, immediately before coating, 140 g of a silver halide-mixed emulsion A was added, and the materials are mixed well to obtain an image forming layer coating solution, which was supplied as it was to a coating die, followed by coating.

A viscosity of the above-mentioned image forming layer coating solution was measured with a B-type viscometer provided by Tokyokeiki. Co. Ltd., and found to be 40 [mPa·s] at 40° C. (No. 1 rotor, 60 rpm).

A viscosity of a coating solution at 38° C. as measured using RheoStress RS 150 (trade name, manufactured by Haake) was 30, 43, 41, 28 or 20 [mPa·s], respectively, at a shear rate of 0.1, 1, 10, 100 or 1000 [1/second].

An amount of zirconium in the coating solution was 0.30 mg per 1 g of silver.

Preparation of Immediate Layer Coating Solution

27 ml of a 5% by weight aqueous solution of Aerosol OT (trade name, manufactured by American Cyanamide) and 135 ml of a 20% by weight aqueous solution of a diammonium salt of phthalic acid were added to 1000 g of polyvinyl alcohol (trade name: PVA-205, manufactured by Kurarey Co., Ltd.), 163 g of the pigment-1 dispersion, 33 g of an aqueous blue dye compound-1 (trade name: Kayafectototarcoize RN liquid 150, manufactured by Nippon Kayaku Co., Ltd.) solution, 27 ml of a 5% aqueous solution of a sodium salt of di(2-ethylhexyl) sulfosuccinate, and 4200 ml of a 19% by weight solution of methyl methacrylate/styrene/butyl acrylate/hydroxyethyl methacrylate/acrylic acid copolymer (copolymerization ratio 57/8/28/5/2) latex, and filled up with water to a total amount of 10000 g. pH thereof was adjusted to 7.5 with NaOH to obtain an intermediate layer coating solution, which was supplied to a coating die at 8.9 ml/m².

A viscosity of a coating solution was 58 [mpa·s] as measured by B-type viscometer (No. 1 rotor, 60 rpm) at 40° C.

Preparation of Coating Solution of First Layer of Surface Protecting Layer

100 g of inert gelatin and 10 mg of benzoisothiazolinone were dissolved in 800 ml of water, and 180 g of a 19% by weight solution of methyl methacrylate/styrene/butyl acrylate/hydroxyethyl methacrylate/acrylic acid copolymer (copolymerization ratio 57/8/28/5/2) latex, 10% by weight of a solution of phthalic acid derivative (kind and amount thereof are shown in Table 1) in methanol, 5.5 ml of a 1% by weight solution of a fluorine type surfactant (F-1), 5.5 ml of a 1% by weight aqueous solution of a fluorine type surfactant (F-2), 28 ml of a 5% by weight aqueous solution of a sodium salt of di(2-ethylhexyl)sulfosuccinate, 4 g of a polymethyl methacrylate fine particle (average particle diameter 0.7 μm) and 21 g of a polymethyl methacrylate fine particle (average particle diameter 4.5 μm) were mixed therein to obtain a surface protecting layer coating solution, which was supplied to a coating die at 8.3 ml/m².

A viscosity of the coating solution was 19 [mPa·s] as measured by a B-type viscometer (No. 1 rotor, 60 rpm) at 40° C.

Preparation of Photothermographic Materials-1 to 7

Simultaneous overlaying coating was performed on a surface opposite to the back surface in an order of an image forming layer, an intermediate layer, a first layer of a protecting layer and a second layer of the protecting layer from the undercoated surface in a slide bead coating method, to prepare a sample of a photothermographic material. Thereupon, the image forming layer and the intermediate layer were adjusted at 31° C., the first layer of the protecting layer was adjusted at 36° C., and the second layer of the protecting layer was adjusted at 37° C.

A coating amount (g/m²) of each compound in the image forming layer was as follows:

| | |
|---|---|
| Silver behenate | 5.27 |
| Pigment (C.I. Pigment Blue 60) | 0.036 |
| Polyhalogen compound-1 | 0.14 |
| Polyhalogen compound-2 | 0.28 |
| Phthalazine derivative | (kind and amount thereof are |
| | shown in Table 1) |
| SBR-latex | 9.43 |
| Reducing agent-1 | 0.77 |
| hydrogen bond-forming compound-1 | 0.28 |
| Development promoter-1 | 0.019 |
| Development promoter-2 | 0.016 |
| Color tone adjuster | 0.006 |
| Mercapto compound-2 | 0.003 |
| Silver halide (as in amount of Ag) | 0.13 |

The coating drying conditions were as follows:

Coating was performed at a speed of 160 m/min, a gap between a tip of a coating die and a support was 0.10 to 0.30 mm, and a pressure in an evacuating chamber was set low by 196 to 882 Pa relative to the atmospheric pressure. The support was subjected to eliminate of electricity with an ionic wind before coating.

Subsequently, in a chilling zone, the coating solution was cooled with a wind at a dry-bulb temperature of 10 to 20° C., conveyed in contactless manner, and dried with a dry wind at a dry-bulb temperature of 23 to 45° C. and a wet-bulb temperature of 15 to 21° C. using a helical contactless drying apparatus.

After drying and humidity conditioning at 25° C. and humidity of 40 to 60% RH, the photothermographic material was heated so that a temperature of a film surface thereof become 70 to 90° C. After heating, a film surface was cooled to 25° C.

A matting degree of the prepared photothermographic material as Beck smoothness was 540 seconds in the photosensitive layer side and 120 seconds in the back side. In addition, a pH of a film surface on the photosensitive surface side was measured and found to be 6.0.

Chemical structures of compounds used in Examples of the invention will be shown below. 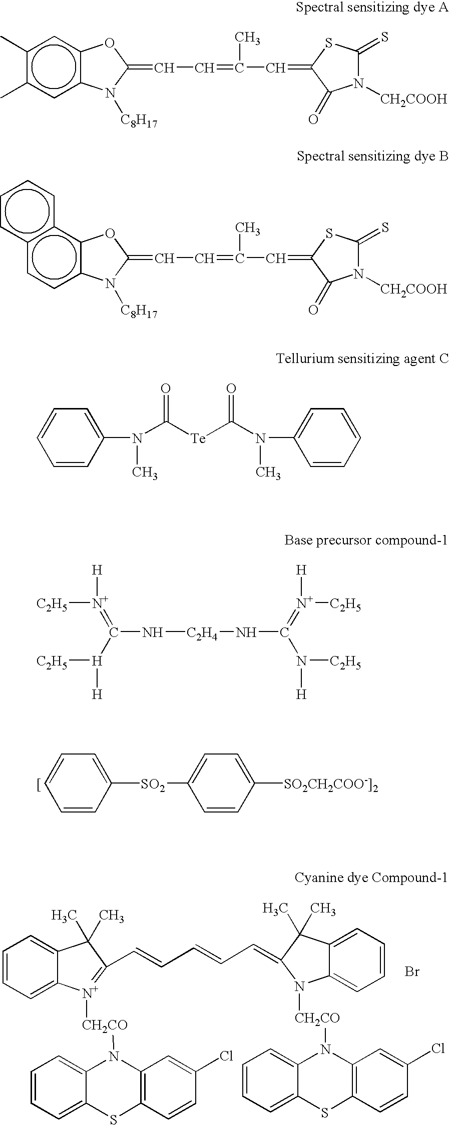 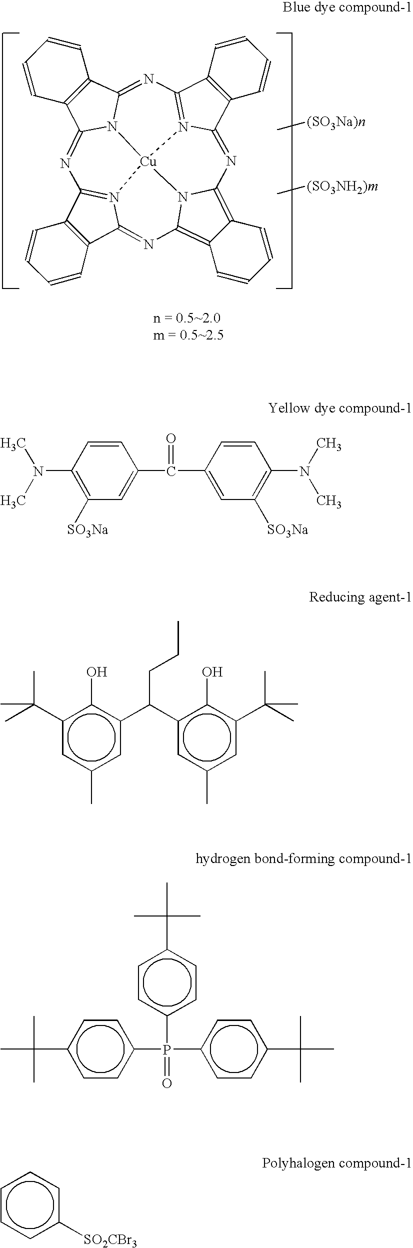 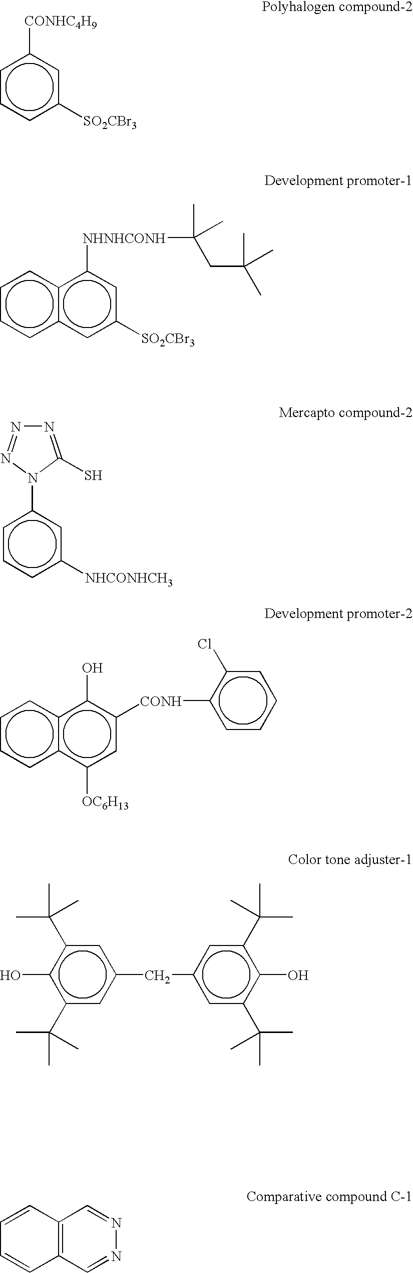 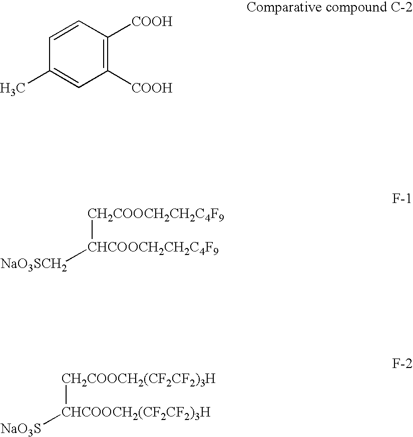
Evaluation of Photographic Property
1) Preparations for Evaluation

The resulting sample was cut into a half cut size, packaged into the following packaging material under the environment at 25° C. and 50%, stored under a normal temperature for 2 hours, and subjected to the following evaluation.

Packaging Material

PET 10 μ/PE 12 μ/aluminium foil 9 μ/Ny 15 μ/polyethylene containing 3% carbon 50μ
Oxygen permeability: 0.02 ml/atm·m²·25° C.·day, Moisture permeability: 0.10 g/atm·m²·25° C.·day

The photothermographic material-1 was exposed with a dry laser imager (equipped with 660 nm semiconductor laser having 60 mW (IIIB) output at maximum) (trade name: FM-DP L, manufactured by Fuji Medical Co. Ltd,.) and thermally developed by a thermal developing device shown in FIG. 1 in both cases of with or without setting a filter for collecting volatilized material, using three panel heaters set at 112° C.-119° C.-121° C.-121° C. The photothermographic material-1 was treated for a total of 14 seconds. A diameter of an air cooling fan equipped with an outlet was 15 cm, a wind velocity of an exhaust of the air cooling fan was 0.6 m/second, and a wind amount at the outlet of the air cooling fan was 636 1/minute.

Evaluation of Results

Evaluating Methods

(1) Odor

Immediately after 100 sheets of photothermographic materials are continuously treated, odor near an air-cooling fan outlet of a used thermal developing device was functionally evaluated by five persons.
⊚: None of the persons feel bad odor.
◯: Only one out of the persons feels bad odor.
Δ: Three out of the persons feel bad odor.
X: All the persons feel bad odor.

It is necessary for practical use that the photothermographic materials are evaluated as ◯ or ⊚.

(2) Quantitative Analysis of the Volatilized Amount in the Thermal Developing Device

To consider a precipitation discharged outside from the thermal developing device, the volatilized amount of a material discharged outside the thermal developing device was quantitatively analyzed. As the volatilized and scatted amount was smaller, the amount of the precipitation from the thermal developing device was favorably smaller.

Under the above-mentioned conditions, 300 sheets having a rolled letter paper size are continuously treated, and entire wind sent out from the air-cooling fan outlet of the thermal developing device was collected. Volatilized and scatted material in the wind was trapped with a water-cooling tube in which water 2° C. in temperature was caused to flow. The water-cooling tube was washed with methanol and chloroform. The resultant liquid was concentrated, and then liquid chromatography was used to analyze the volatilized material quantitatively. The results were shown in Table 1. In Table 1, the wording “detection limit or less” represents a level at which no precipitation discharged outside the thermal developing device was observed.

(3) Evaluation of the Photographic Performance

The optical density of the non-exposed portion of the above-mentioned treated sample was measured as Dmin, and the density of the portion exposed at a highest exposure amount was measured as Dmax to evaluate the photographic performance of the sample.

(4) Measurement of the Volatilization Remaining Ratio

In accordance with the method described (in the item “Description on the volatilization remaining ratio”) in the text, each of the photosensitive material samples was measured. The volatilization remaining ratio of each of organic compounds applied in an amount of 0.1 g/m² or more in each of the photothermographic materials-1 to 7 was as follows:

| | |
|---|---|
| Silver behenate | 94% |
| Polyhalide compound-1 | 81% |
| Polyhalide compound-2 | 98% |
| Phthalazine compound derivative | (described in Table 1) |
| Reducing agent-1 | 80% |
| Hydrogen-bonding compound-1 | 100% |
| Phthalic acid derivative: | described in Table 1 |
| Basic precursor compound | 67% |

About the Evaluation Results

As is evident from Table 1, the volatilization remaining ratio of each of the phthalazine derivative and phthalic acid derivative specified in the invention was 50% or more. On the other hand, the volatilization remaining ratio of the comparative compound C-1 is 28%, and that of the comparative compound C-2 was 0%. These two values were very low. The volatilization remaining ratios of the compounds other than the phthalazine derivative and phthalic acid derivative were 50% or more.

About the odor when the photothermographic materials were actually treated continuously in the thermal developing device and the discharged amount of the volatilized material, results reflecting the resultant volatilization remaining ratio were obtained. In the case that the phthalazine derivative and phthalic acid derivative specified in the invention were used, the amount of the resultant the volatilized material was small even if no activated carbon filter is set up. The degree of the odor in this case was such a degree that only one of the five persons felt bad odor slightly. When such a filter was set up in this case, no volatilized material was detected and no odor was detected.

TABLE 1

| | | | | | | | Filter of | | | | | | |
|---|---|---|---|---|---|---|---|---|---|---|---|---|---|
| | | | | | | | the ther- | | | | | | |
| | Phthalazine derivative | | | Phthalic acid derivative | | | mal de- | | | | | | |
| Exper- | | Volatilization | | | Volatilization | | velo- | Photographic | | | Quantitative analysis | | |
| iment | | remaining ratio | Amount | | remaining ratio | Amount | ping | performance | | Bad | Phthalazine | Phthalic acid | |
| No. | Kind | at 160° C. | (mg/m²) | Kind | at 160° C. | (mg/m²) | device | Dmin | Dmax | odor | derivative | derivative | Notes |
| 1 | I-7 | 73 | 172 | II-1 | 99 | 183 | Set up | 0.17 | 4.1 | ⊚ | Detection | Detection | The |
| | | | | | | | | | | | limit or less | limit or less | invention |
| 2 | I-7 | 73 | 172 | II-1 | 99 | 183 | Not set | 0.17 | 4.1 | ◯ | 3 | Detection | The |
| | | | | | | | up | | | | | limit or less | invention |
| 3 | C-1 | 28 | 130 | II-1 | 99 | 183 | Set up | 0.17 | 3.9 | Δ | 10 | Detection | Compara- |
| | | | | | | | | | | | | limit or less | tive Ex- |
| | | | | | | | | | | | | | ample |
| 4 | C-1 | 28 | 130 | C-2 | 0 | 162 | Set up | 0.17 | 3.8 | X | 10 | 18 | Compara- |
| | | | | | | | | | | | | | tive Ex- |
| | | | | | | | | | | | | | ample |
| 5 | I-10 | 80 | 186 | II-1 | 99 | 183 | Set up | 0.17 | 4.0 | ⊚ | Detection | Detection | The |
| | | | | | | | | | | | limit or less | limit or less | invention |
| 6 | I-3 | 67 | 158 | II-1 | 99 | 183 | Set up | 0.17 | 4.1 | ⊚ | Detection | Detection | The |
| | | | | | | | | | | | limit or less | limit or less | invention |
| 7 | I-10 | 80 | 186 | II-1 | 99 | 183 | Not set | 0.17 | 4.0 | ◯ | 3 | Detection | The |
| | | | | | | | up | | | | | limit or less | invention |

### Example 2

600 sheets of the photothermographic material of Experiment No. 1 in Example 1 were continuously caused to pass through the thermal developing device in a room 2 m long, 2 m wide and 2 m high under the condition of a developing time of 14 seconds. Thereafter, odor in the room was evaluated. The same experiment was conducted under the condition of a developing time of 24 seconds. Thereafter, odor in the room was evaluated.

As a result, in the case of the 14-second development, no odor was felt. In the case of the 24-second development, odor was slightly felt. It is proved that the 14-second development was superior since volatilized material was less discharged and bad odor was less generated in this case.

### Example 3

The same experiment was conducted except that zeolite was used instead of the activate carbon filter used in Experiment No. 1 in Example 1. Similar results were obtained.

### Example 4

The same experiment was conducted except that silica was used instead of the activate carbon filter used in Experiment No. 1 in Example 1. Similar results were obtained.

The invention provides a photothermographic material and an image forming method which generate little odor and minimizes stains in a thermal developing device. While the present invention has been described with reference to preferred materials and embodiments, it is understood that the invention is not limited to such embodiments. Various modifications and equivalents may be used without departing from the invention.

What is claimed is:

1. A photothermographic material comprising a substrate and a composition disposed thereon, wherein:
the composition comprises a photosensitive silver halide, a non-photosensitive organic silver salt, a reducing agent for thermal development and a binder; wherein
each of organic compounds comprised in an amount of approximately 0.05 g/m² or more in the composition has a volatilization remaining ratio of 50% or more at 160° C.

2. A photothermographic material according to claim 1, wherein at least one of the organic compounds is represented by the following general formula (I): 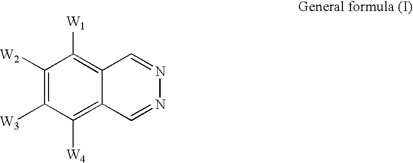
wherein each of W₁ to W₄ independently represents a hydrogen atom or a monovalent substituent, and at least one of W₁ to W₄ is a monovalent substituent.

3. A photothermographic material according to claim 1, wherein at least one of the organic compounds is represented by the following general formula (II): 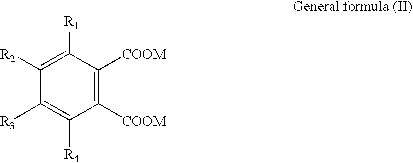
wherein each of R₁ to R₄ independently represent a hydrogen atom or a monovalent substituent, and when three out of R₁ to R₄ are hydrogen atoms, a remaining monovalent substituent is a group other than a methyl group; and M represents a hydrogen atom, an alkali metal, an alkali earth metal, an ammonium group, or a phosphonium group.

4. A photothermographic material according to claim 1, which comprises at least one compound selected from the compounds represented by the following general formula (I) and at least one compound selected from the compounds represented by the following general formula (II): 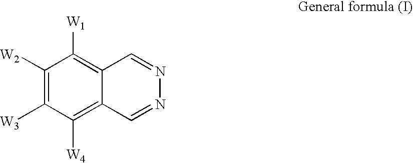
wherein each of W₁ to W₄ independently represents a hydrogen atom or a monovalent substituent, and at least one of W₁ to W₄ is a monovalent substituent: 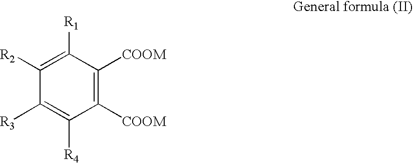
wherein each of R₁ to R₄ independently represents a hydrogen atom or a monovalent substituent, and when three out of R₁ to R₄ are hydrogen atoms, a remaining monovalent substituent is a group other than a methyl group; and M represents a hydrogen atom, an alkali metal, an alkali earth metal, an ammonium group, or a phosphonium group.

5. A method for forming an image by heating an exposed photothermographic material using a thermal developing device, wherein
the thermal developing device comprises a filter for collecting volatilized substances, and
the photothermographic material comprises a substrate and a composition disposed thereon, wherein:
the composition comprises a photosensitive silver halide, a non-photosensitive organic silver salt, a reducing agent for thermal development and a binder; wherein
each of organic compounds comprised in an amount of approximately 0.05 g/m² or more in the composition has a volatilization remaining ratio of 50% or more at 160° C.

6. An image forming method according to claim 5, wherein at least one of the organic compounds is represented by the following general formula (I): 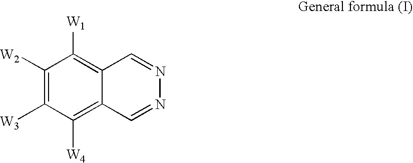
wherein each of W₁ to W₄ independently represents a hydrogen atom or a monovalent substituent, and at least one of W₁ to W₄ is a monovalent substituent.

7. An image forming method according to claim 5, wherein at least one of the organic compounds is represented by the following general formula (II): 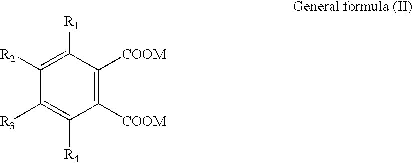
wherein each of R₁ to R₄ independently represents a hydrogen atom or a monovalent substituent, and when three out of R₁ to R₄ are hydrogen atoms, a remaining monovalent substituent is a group other than a methyl group; and M represents a hydrogen atom, an alkali metal, an alkali earth metal, an ammonium group, or a phosphonium group.

8. An image forming method according to claim 5, wherein the photothermographic material comprises at least one compound selected from the compounds represented by the following general formula (I) and at least one compound selected from the compounds represented by the following general formula (II): 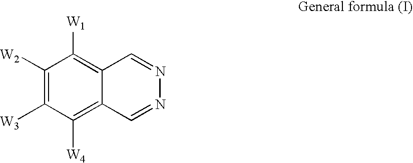
wherein each of W₁ to W₄ independently represents a hydrogen atom or a monovalent substituent, and at least one of W₁ to W₄ is a monovalent substituent: 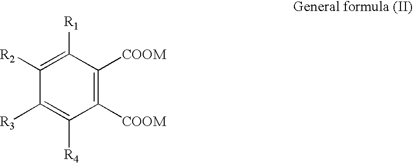
wherein each of R₁ to R₄ independently represents a hydrogen atom or a monovalent substituent, and when three out of R₁ to R₄ are hydrogen atoms, a remaining monovalent substituent is a group other than a methyl group; and M represents a hydrogen atom, an alkali metal, an alkali earth metal, an ammonium group, or a phosphonium group.

9. An image forming method according to claim 5, wherein the time for thermal development is in a range of 7 to 15 seconds.
